(19) United States
(12) Patent Application Publication
(10) Pub. No.: US 2018/0115520 A1
(43) Pub. Date: Apr. 26, 2018

(54) DARK VIRTUAL PRIVATE NETWORKS AND SECURE SERVICES

(71) Applicant: IsoNetic, Inc., Vashon, WA (US)

(72) Inventors: Diana NEUMAN, Vashon, WA (US); Michael NEUMAN, Vashon, WA (US); Bobby KANDASWAMY, Corbett, OR (US)

(21) Appl. No.: 15/789,909

(22) Filed: Oct. 20, 2017

Related U.S. Application Data
(60) Provisional application No. 62/410,659, filed on Oct. 20, 2016.

(51) Int. Cl. H04L 29/06

(52) U.S. Cl. CPC H04L 63/0272; H04L 63/0823; H04L 63/061; H04L 63/0884; H04L 63/0281; H04L 63/0435; H04L 63/0442

(57) ABSTRACT

Provided herein are systems and methods for establishing secure communications and connectivity between agents (client, user, or service) over any physical network topology. The system allows clients (client, user, or service agents) to connect to services in a secure manner reducing risks from third party trust attacks, denial-of-service, and anonymous attacks (either zero-day or using known vulnerabilities) while simultaneously improving the performance of the connectivity.

### CROSS-REFERENCE TO RELATED APPLICATIONS

This application claims the benefit of U.S. provisional patent application Ser. No. 62/410,659 (filed 20 Oct. 2016), which is hereby incorporated by reference in its entirety.

### BACKGROUND

Current networks rely on a variety of traditional components that were not created with sufficient security controls, making it very complex to build any type of secure architecture. These insecure framework components make it nearly impossible to properly secure services on computer networks (like web sites, file shares, etc.) from large classes of attacks or to protect users of those services from malicious attacks.

When a user starts a connection to a service, for example a secure web service, the first thing that happens is the user receives a location based on the service name, provided through Domain Name Services (DNS), and routing services. Traditionally critical routing and security information is simply handed out without any validation or integrity checking. This information includes DNS Name to IP-address mappings and routing information on how to reach the IP-address in question. These IP-addresses are used to both route information to the device and act as the identifier of a device on the network. Unfortunately, since IP-address can easily be duplicated, spoofed, or otherwise compromised multiple types of attacks can be used including causing parties in the communication to connect to malicious hosts. Another problem with existing service information systems is that the information can be used by malicious and unapproved users, opening up attacks on the services including Denial of Service (DoS) attacks, network probes, and Zero-day attacks.

After receiving the location and routing information, the user now connects to the secure web service traditionally over TCP/IP. However, TCP/IP is vulnerable to a multitude of attacks. Once a service is started it will accept a number of packets from anyone on the network. For example, TCP/IP will accept an entire connection start-up and only the application layer of the network stack might request a username/password. Even secure protocols, such as IPSec, will accept 2-3 packets before the authentication of the user is verified, and TLS will accept the entire connection before authentication happens. This open period allows attackers to detect the service is available, probe for version numbers, and send any number of attacks that will attempt to be processed.

After the user is connected to the secure web service, they then commonly rely on third party certificates to validate the identity of the server. Unfortunately, there are thousands of signing authorities who are trusted to create legitimate certificates for any server on the Internet. Because there are so many, malicious parties can often get legitimate looking but invalid certificates thereby voiding any security provided by the certificate system. In addition, the only means to mark a certificate as bad is done through Certificate Revocation Lists (CRL). Currently there are potentially a million certificates on CRLs, making checking the list so slow that most browsers simply turn off the checks. This means that an attacker can potentially keep compromising connections for months after the certificate is discovered. In addition, although this system helps validate the service is legitimate, commonly nothing is done to cryptographically validate the user. Configuration of client certificates is so complex and cumbersome that companies just turn off client certificates, falling back to simple username and password.

To prevent some of this risk, services are commonly firewalled or isolated behind a Virtual Private Network (VPN). Traditional Virtual Private Networks are built to connect specific devices (laptops, servers, etc.) to an entire internal organizational network. While preventing some of the malicious attacks to both the services and users of the network, it opens the organizational network up to attacks through the VPN tunnel. Ideally, the connectivity between users accessing organizational services would be limited to just the services that were needed; however, VPNs commonly open up the entire network giving a level of exposure to the internal organization that is unnecessary. In addition, VPN tunnels are designed to connect to a single location so if an organization has some resources in the cloud, some on-site, and some at a remote office the user either has to tunnel all the traffic through a single location, which causes extra costs and loss of performance, or has to manually switch between VPN tunnels for each destination. Neither of these VPN solutions help prevent a number of attacks including Man-in-the-Middle attacks or DoS attacks. Finally, even VPNs traditionally do not control user access in a cryptographically verifiable manner, relying again on username and password to grant access, which are not cryptographically provable and vulnerable to a number of authentication attacks.

The next level of solutions organizations consider, is to deploy something like IPSec to all critical endpoints requiring secure keying material be distributed (usually manually) to every end-point. Commonly keys are managed and created at a central location (i.e. central management console) and then handed out to the parties that need them as communication is expected or established. This architecture places all the critical information of the network at a single centralized location, which should it be attacked would compromise everything on the network. In addition, this architecture assumes that every node will be able to connect to the management console before establishing communication. When nodes are distributed across the world, across different organizations, or exist in isolated unconnected networks this eliminates all functionality provided by the central management console. Also, the key management challenges force enormous burdens on the network administrators, and yet, still don't address many security issues including DNS, IPSec service probes, trusted certificates, etc.

### BRIEF DESCRIPTION OF THE DRAWINGS

FIG. 1 depicts a system configuration showing how one or more included techniques may implement communication channels.

FIG. 2 depicts a client device according to one or more embodiments.

FIG. 3 depicts a server according to one or more embodiments.

FIG. 4 depicts a network security system according to one or more embodiments.

FIG. 5 depicts a high level flow according to one or more embodiments.

FIG. 6 depicts another network security system according to one or more embodiments.

FIG. 7 depicts a higher-level diagram of the architectural components in one or more embodiments.

FIG. 8 depicts a diagram showing the keying information which is used in one or more embodiments, who owns the keys and a high-level view of their purpose.

FIG. 9 depicts a simple configuration of user agent keys.

FIG. 10 depicts a more complex configuration of user agent keys featuring roles and individual community of interest (COI) membership keys.

FIG. 11 depicts a communication flow and detailed event sequence among the four types of parties in a COI, showing the creation of a COI.

FIG. 12 depicts a communication flow and detailed event sequence showing a service start process.

FIG. 13 depicts a communication flow and detailed event sequence showing the communication flow when a user agent connects to a service.

FIG. 14 depicts a diagram identifying the major components within an encrypted information server (EIS) data structure.

FIG. 15 depicts a process diagram showing the EIS verification steps done when a new record is submitted.

FIG. 16 depicts a process diagram showing the verification steps used when a record is retrieved from the EIS by a service, user agent, or other recipient.

FIG. 18 depicts the communication flow diagram between an EIS client and the EIS server during a standard query for a record.

FIG. 19 depicts the communication flow diagram between an EIS client and an EIS server when submitting a record to the EIS server.

FIG. 20 depicts an exemplary EIS Information Record.

FIG. 21 depicts an exemplary EIS Approval Record.

FIG. 22 depicts an exemplary Service Ownership Record.

FIG. 23 depicts an exemplary Private Service Record.

FIG. 24 depicts an exemplary User Membership Record.

FIG. 25 depicts an exemplary Public Service Record.

FIG. 26 depicts an exemplary Machine Owner Policy Record.

FIG. 27 depicts an exemplary Public Lookup Record.

FIG. 28 depicts an exemplary Machine Record.

FIG. 29 depicts a decision chart showing for a sample key rotation system the critical points that determine the next key tuple used when different actions occur.

FIG. 30 depicts a communication flow diagram showing an example communication flow in a predictively accepted communication channel.

FIG. 31 depicts another high level flow according to one or more embodiments.

### DEFINITIONS AND ALTERNATE CATEGORIES OF EMBODIMENTS

Service—any group of functions available over a network. Examples include web services, database services, filesharing, FTP, etc. The service need not be offered over a single IP port (i.e. FTP) or on a single server (i.e. a cluster of web servers).

Agent—Software or circuitry that acts on behalf of an end-point or device to perform a set of functions. The agent can be written in any common programming language, embedded into a chip, or otherwise delivered for multiple operating systems or components.

User Agent or Client Agent—the software that acts on behalf of the user or client. client, client agent or user agent can be used interchangeable, unless specifically noted. For services that communicate in a traditional client-server architecture the client agent performs a set of functions for the client. In a peer-to-peer architecture the client or user agent may directly access functionality offered over the network through the COI.

Service Agent—the software that acts on behalf of the service. The service agent can exist on the same device as the service or be placed on a gateway or relay device in between the service and the client agents accessing the service.

COI—Community of Interest is a group of zero or more user agents accessing zero or more services. The services and user agents are added to the COI by the Network Owner. The COI becomes a virtual overlay controlling access and service discovery across any type of network (i.e. LAN, WAN, etc.).

Network Owner—the software that manages one or more COIs. In a distributed model any user agent can become a Network Owner. In some other embodiments the Network Owner software may be more centralized managing COIs across an entire organization and may or may not also as a user agent. The centralized approach would more closely resemble a central management console (CMC).

EIS—Encrypted Information Server an information distribution server allowing clients to query and post a variety of both public and private data records in a secure manner. In one or more preferred embodiments the EIS is implemented primarily on top of a traditional DNS server and architecture. However other embodiments could include a directed messaging service or publish/subscribe structure.

Service Provider—Any agent that offers one or more services for inclusion into a COI. The services offered do not have to be secure or behind the SPProtocol. Service providers can offer services from any network location (LAN, WAN, Cloud, Disconnected) etc.

SPProtocol—For the purposes of some embodiments the basic protocol follows that as described in “MinimaLT: Minimal-Latency Networking Through Better Security” by Petullo, W. M. ET AL. (attached hereto as Appendix A). The technology herein describes additions to the basic protocol structure to support different types of connections and first packet data. The resulting protocol will be called the SPProtocol for the purposes of this description.

User Device—Any device a user or automated process can interact with including Smart Phones, Desktops, Laptops, Tablets, embedded processors (thermostats, IoT devices), etc.

Communication Protocol—Any method used to exchange information between two parties. Examples include IPSec, TCP/IP, SPProtocol, etc

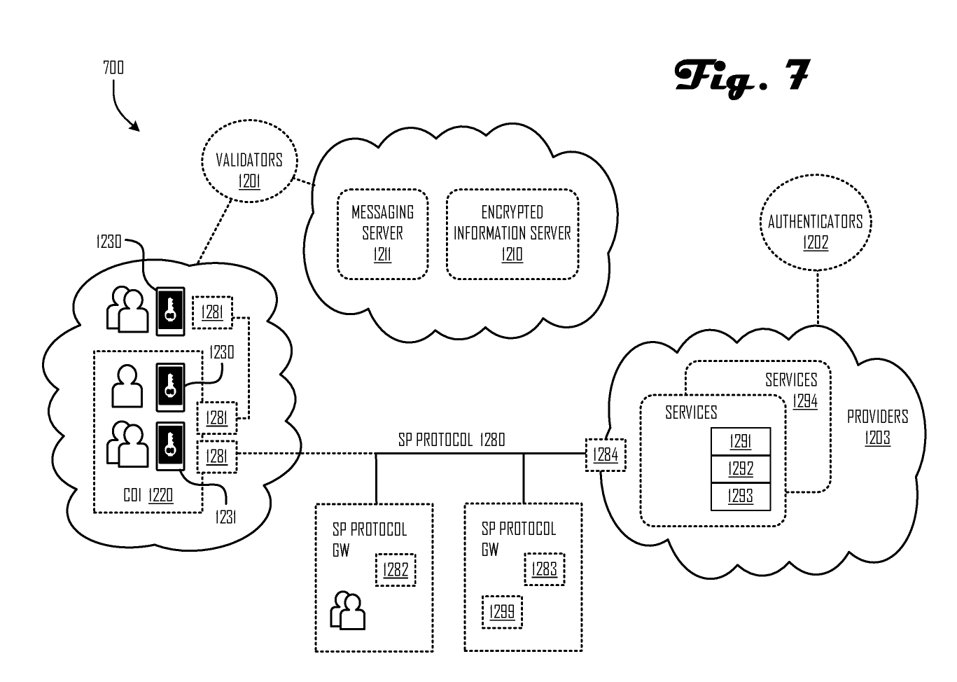

Secure Service—Any end-point that can accept secure connections. This would include services that use the SPProtocol as a communication library and talk a secure protocol directly. Although the SPProtocol is one or more preferred embodiments, any communication protocol could be used, ideally which provides encryption. Secure service may also include services that are behind a gateway device or service that decodes the secure traffic and transfers the data to the services behind the gateway (See FIG. 7). Secure service access could also be done by a gateway that secures the traffic from multiple user devices before sending it to secure services (See FIG. 7).

Architectural Integration Points—These are well defined interfaces into an architecture that allow external software to interact with the system. For example, if an organization already maintains a list of users, an integration point may allow existing user lists to be imported and used by the system. Commonly these integration points are defined by an Application Programming Interface or other specification for low level integration or through a set of scripts or tools for higher level integrations.

Perfect Forward Secrecy—provides protections such that when members of a group are removed the privacy of future messages or communications remains intact and the members who were removed are excluded.

Perfect Backwards Secrecy—provides protection such that when a new member is added to a group they cannot see previous messages.

### DETAILED DESCRIPTION

The detailed description that follows is represented largely in terms of processes and symbolic representations of operations by conventional computer components, including a processor, memory storage devices for the processor, connected display devices and input devices. Furthermore, some of these processes and operations may utilize conventional computer components in a heterogeneous distributed computing environment, including remote database servers, computer servers and memory storage devices.

It is intended that the terminology used in the description presented below be interpreted in its broadest reasonable manner, even though it is being used in conjunction with a detailed description of certain example embodiments. Although certain terms may be emphasized below, any terminology intended to be interpreted in any restricted manner will be overtly and specifically defined as such.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Apparent,” “associated,” “at least,” “automatic,” “based,” “better,” “between,” “capable,” “compatible,” “complete,” “conditional,” “configured,” “consecutive,” “corresponding,” “current,” “dark,” “each,” “encrypted,” “existing,” “first,” “having,” “higher,” “in,” “intermediate,” “internal,” “local,” “lower,” “maximum,” “minimum,” “mobile,” “new,” “nominal,” “on,” “other,” “partly,” “performed,” “proximate,” “published,” “real-time,” “recognized,” “remote,” “resident,” “respective,” “responsive,” “scalar,” “scheduled,” “second,” “selected,” “sequential,” “several,” “target,” “tentative,” “third,” “triggered,” “usable,” “while,” “with,” or other such descriptors herein are generally used in their normal yes-or-no sense, not merely as terms of degree, unless context dictates otherwise. In light of the present disclosure those skilled in the art will understand from context what is meant by “remote” and by other such positional descriptors used herein. Terms like “processor,” “center,” “unit,” “computer,” or other such descriptors herein are used in their normal sense, in reference to an inanimate structure. Such terms do not include any people, irrespective of their location or employment or other association with the thing described, unless context dictates otherwise. “For” is not used to articulate a mere intended purpose in phrases like “circuitry for” or “instruction for,” moreover, but is used normally, in descriptively identifying special purpose software or structures. As used herein, the term “contemporaneous” refers to circumstances or events that are concurrent or at least roughly contemporaneous (on the same day, e.g.).

Reference is now made in detail to the description of the embodiments as illustrated in the drawings. A computer implemented method is disclosed that allows clients, either user agents or service agents, to securely find and connect to services. The method relates to key management, secure protocols, secure information sharing, architectural integration points, and the like. While embodiments are described in connection with the drawings and related descriptions, there is no intent to limit the scope to the embodiments disclosed herein. On the contrary, the intent is to cover all alternatives, modifications, and equivalents. In alternate embodiments, additional agents, or combinations of illustrated agents, may be added to, or combined, without limiting the scope to the embodiments disclosed herein. For example, the embodiments set forth below are primarily described in the context of a distributed model where it is assumed where any user agent can become a Network Owner. However, these embodiments are exemplary and are in no way limited to such a distributed model. For example, other embodiments may utilize more centralized control, in which case the Network Owner may focus on COI management and may or may not also act as a user agent.

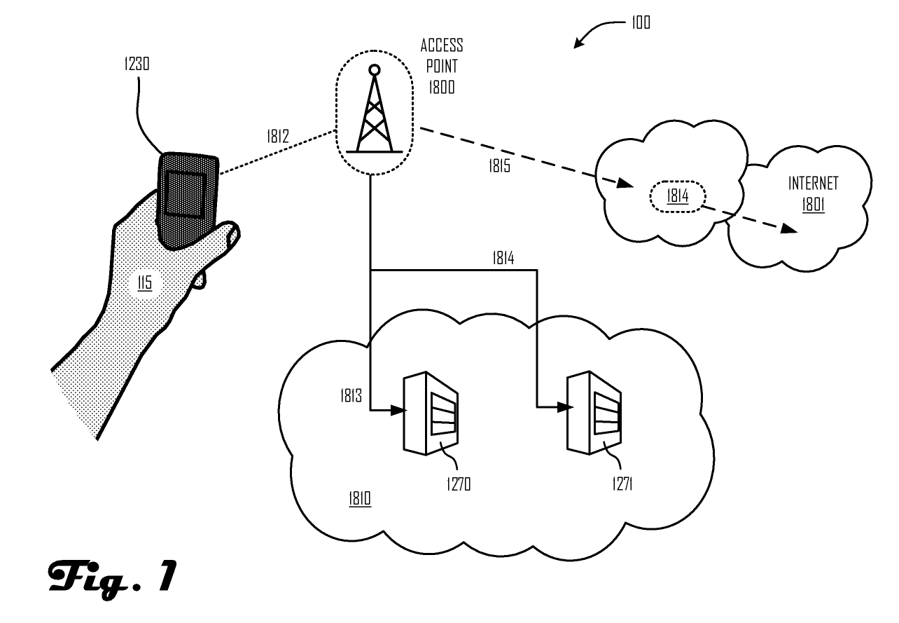

The embodiments described herein allow clients (user agents and services) to securely communicate. FIG. 1 depicts a sample embodiment showing how one or more included techniques implement communication channels. When a user agent (user 115 and user agent 1230 acting jointly, e.g.) connects to the Internet 1801 through (one or more wireless linkages 1812 and) an untrusted access point 1800, by using the SPProtocol at items 1813, 1814 for secured access to secure organizational services (at item 1270 and at item 1271 of an organizational entity 1810) and using the SPProtocol at item 1815 to connect to a gateway at item 1814 providing filtered Internet access, the user agent can be protected from Internet attacks. Since the security of SPProtocol connections are independent of any routing or traditional Internet obtained information (certificate revocation lists, etc.) the security of both the organizational services and generic Internet access is improved. As all the traffic to the secure services can be routed directly via item 1814 to the services, there is no need for additional gateway devices to route all traffic both secured organizational and Internet. In addition, the filtered Internet gateway can eliminate common attacks (like pinned certificates, known untrustworthy certificate signatories) or it can be used to provide improvements to the Internet data stream (like ad-blocking, Quality of Service on connections, etc.).

In some embodiments, the user device or user agent may route all of the traffic not destined for specific secured services to the Filtered Internet, and in other embodiments only specific domains, IP-addresses, or traffic during specific periods would be routed to the Filtered Internet. Since no static routing has to be included for specific secured services, the user agent can route traffic directly to different secured services at the same time even if the services exist in different physical networks, at different organizations, or even use a different local network interface (i.e. one secured service exists on local mesh network while a second service is accessed over the WiFi).

In addition, if all traffic out of the User Device is routed to the Filtered Internet gateway, the gateway can perform common internal intrusion detection functions (like looking for data being sent over known back door ports or protocols) even through the user device is not on the organizational network. This technique could work across all types of devices including IoT devices, and embedded devices.

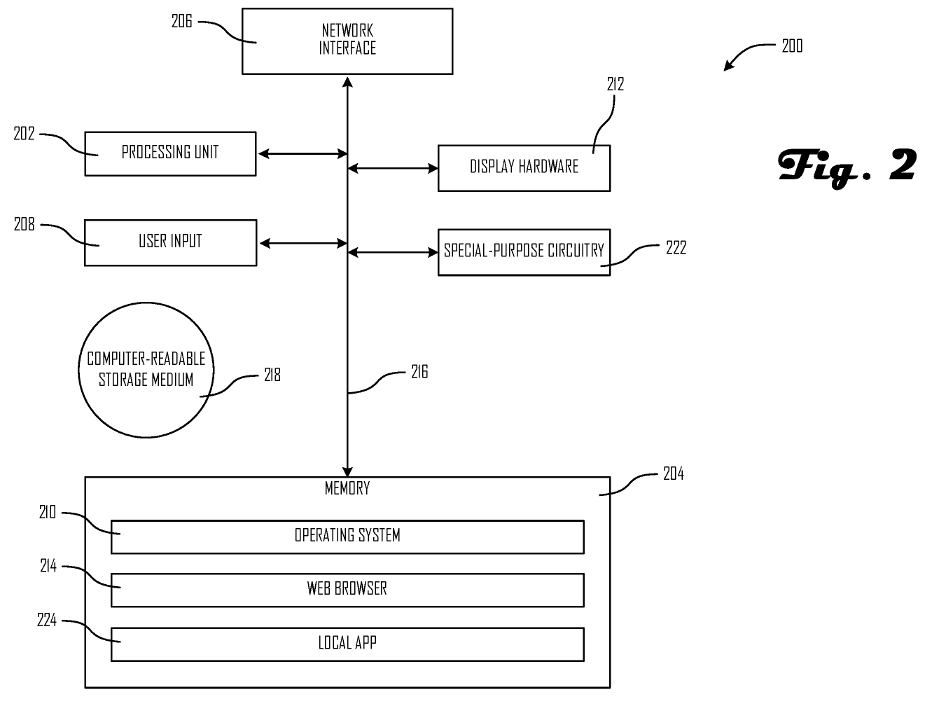

FIG. 2 illustrates several components of an exemplary client device 200 (a handheld device or other intelligent peripheral, e.g.). In some embodiments, client device 200 may include many more components than those shown in FIG. 2 (a dongle, e.g.). However, it is not necessary that all conventional components be shown in order to disclose an illustrative embodiment. As shown in FIG. 2, client device 200 includes a data network interface 206 (for connecting via the Internet or other networks to or to mobile manufacturing units or other smart devices as described herein, e.g.).

Client device 200 may also include one or more instances of processing units 202, memory 204, user inputs 208, and display hardware 212 all interconnected along with the network interface 206 via a bus 216. Memory 204 generally comprises a random access memory (“RAM”), a read only memory (“ROM”), and a permanent mass storage device, such as a disk drive.

Memory 204 may likewise contain one or more instances of operating systems 210, web browsers 214, and local apps 224. These and other software components may be loaded from a non-transitory computer readable storage medium 218 into memory 204 of the client device 200 using a drive mechanism (not shown) associated with a non-transitory computer readable storage medium 218, such as a floppy disc, tape, DVD/CD-ROM drive, flash card, memory card, or the like. In some embodiments, software components may also be loaded via the network interface 206, rather than via a computer readable storage medium 218. Special-purpose circuitry 222 may, in some variants, include some or all of the event-sequencing logic described herein (including transistor-based circuitry within an imaging module 260 configured to capture interior image data that depicts a borehole as described herein, e.g.).

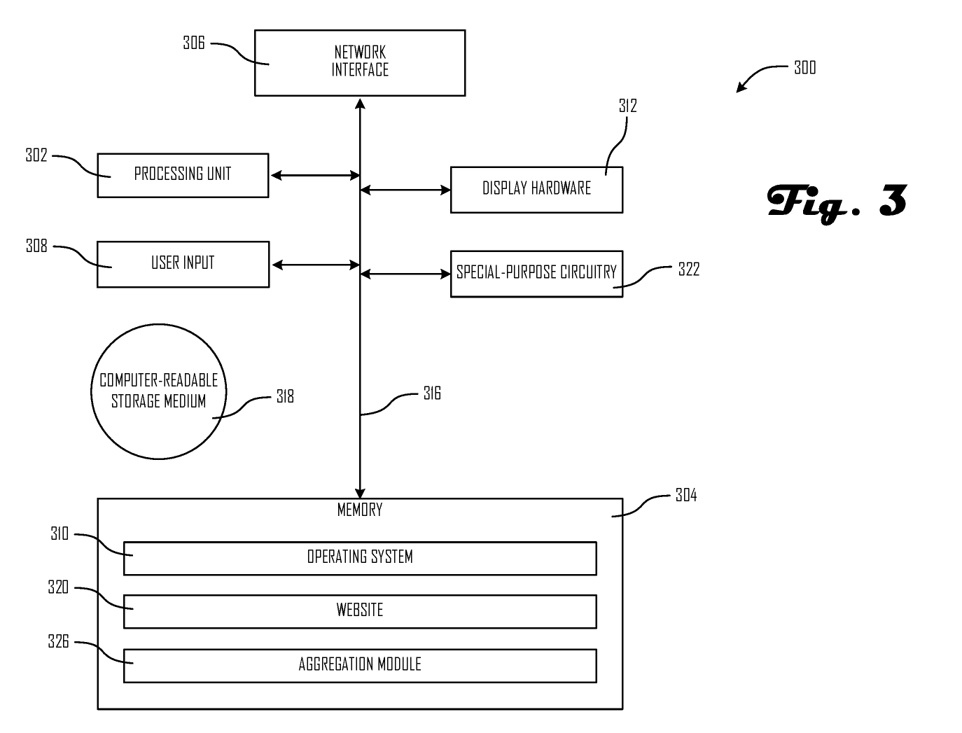

FIG. 3 illustrates several components of an exemplary server 300. As shown in FIG. 3, server 300 includes a data network interface 306 for connecting via the Internet or other networks (or both). As used herein, a plain reference numeral (like 300, e.g.) may refer generally to a member of a class of items (like client devices, e.g.) exemplified with a hybrid numeral (like 300A, e.g.) and it will be understood that every item identified with a hybrid numeral is also an exemplar of the class.

Server 300 may also include one or more instances of processing units 302, memory 304, user inputs 308, and display hardware 312 all interconnected along with the network interface 306 via a bus 316. Memory 304 generally comprises a random access memory (“RAM”), a read only memory (“ROM”), and a permanent mass storage device, such as a disk drive.

Memory 304 may likewise contain an operating system 310, hosted website 320, and aggregation module 326. These and other software components may be loaded from a non-transitory computer readable storage medium 318 into memory 304 of the server 300 using a drive mechanism (not shown) associated with a non-transitory computer readable storage medium 318, such as a floppy disc, tape, DVD/CD-ROM drive, flash card, memory card, or the like. In some embodiments, software components may also be loaded via the network interface 306, rather than via a computer readable storage medium 318. Special-purpose circuitry 322 may, in some variants, include some or all of the event-sequencing logic described below.

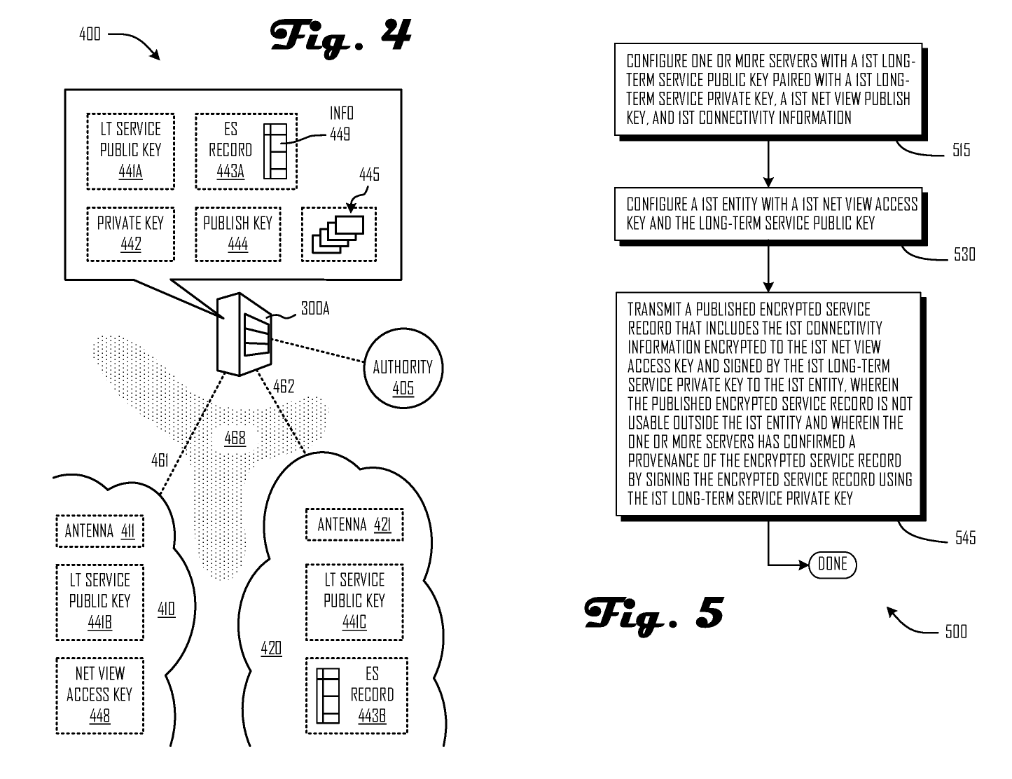

FIG. 4 depicts a network service security system 400 according to one or more embodiments described herein. One or more servers 300 associated with one or more trusted authorities 405 may communicate via a linkage 461 across a free space medium 468 (air, e.g.) and a remote antenna 411 with an entity 410 (comprising a user agent 1230 or other client device 200, e.g.). Likewise the one or more servers 300 associated with one or more trusted authorities 405 may communicate via a linkage 462 across free space medium 468 and a remote antenna 421 with a second entity 420. (As used herein, an “authority” refers either to an entity that is trusted by another entity (a service, e.g.) or to an entity to which such trust has been delegated.)

As shown, server 300A includes (in a memory 304 or other storage medium 318 thereof, e.g.) at least a long-term service public key 441A paired with a long-term service private key 442, an encrypted service record (ESR) 443A containing particular information 449 as described below, a publish key 444, and one or more modules 445 (as components of special-purpose circuitry 322, e.g.). As shown, entity 410 includes one or more instances of antennas 411, of long-term service public keys 441B, or of net view access keys 448 for facilitating secure communications. Likewise entity 420 includes one or more instances of antennas 421, of long-term service public keys 441C, or of encrypted service records 443B by which to attempt to access the one or more servers.

FIG. 5 depicts a high-level flow 500 (network service security method, e.g.) according to one or more embodiments described herein. Operation 515 describes configuring one or more servers (having special-purpose circuitry 322) to contain a first long-term service public key paired with a first long-term service private key and also to contain a first net view publish key as well as first connectivity information (configuring one or more modules 445 so that one or more servers 300A contain a long-term service public key 441A paired with a long-term service private key 442 and also to contain a first net view publish key 444 as well as first connectivity information 449, e.g.). This can occur, for example, in a context in which the one or more servers 300 are configured to interact (via a linkage 461, e.g.) with a first entity 410 (a user agent 1230 or other client device 200 having a user 115, e.g.) having a first net view access key 448 and the long-term service public key 441B (i.e. another instance of long-term service public key 441); and in which publish key 444 and net view access key 448 are symmetrical. In other contexts publish key 444 may be paired (as a public key) with net view access key 448 (as a corresponding public key).

Operation 530 describes configuring a first entity with a first net view access key and the long-term service public key (configuring entity 410 with another copy of the long-term service public key 441B as well as a first net view access key 448 that matches or is paired with publish key 444, e.g.). This can occur, for example, in a context in which entities 410, 420 are each an instance of client device 200 having one or more processing units 202 for communicating with the one or more servers 300 (with server 300A via a respective network interface 206 and one or more wireless linkages 461, 462 across a free space medium 468, e.g.). Alternatively or additionally, one or more modules 445 may be configured to perform operation 530 (in lieu of or in conjunction with a processing unit 202, e.g.). As used herein, an “entity” refers to one or more local or distributed devices (peripherals or client devices 200, e.g.) in use by or for one or more automated processes or human users 115.

Operation 545 describes transmitting a published encrypted service record that includes the first connectivity information encrypted to the first net view access key and signed by the first long-term service private key to the first entity (one or more modules 445 transmitting an instance of a published encrypted service record 443 that includes the first connectivity information 449 encrypted to the first net view access key 448 and signed by the first long-term service private key 442 to the first entity 410, e.g.). This can occur, for example, in a context in which the published encrypted service record 443 is widely available but not usable outside the first entity 410 (i.e. by virtue of being decryptable only via the net view access key 448); in which the one or more servers 300 has confirmed a provenance of the encrypted service record 443A by signing the encrypted service record 443A using the first long-term service private key 442; in which the first entity 410 could not otherwise be confident in the provenance of an ESR 443 that has arrived at the first entity 410; and in which the first entity 410 is thereby able to trust the one or more servers 300 much sooner (without needing to receive and validate new certificates from the server 300A, e.g.) or in which another entity 420 having a valid long-term service public key 441C and ESR 443B would otherwise be able to gain access into server 300A.

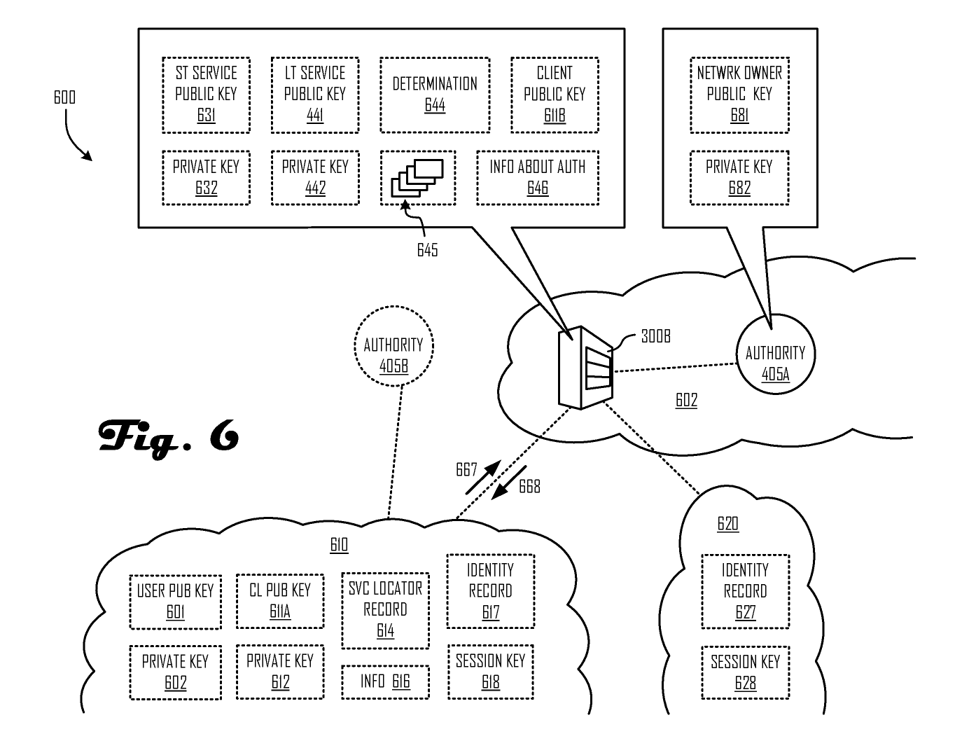

FIG. 6 depicts a network service security system 600 according to one or more embodiments described herein. One or more servers 300 associated with one or more trusted authorities 405A may communicate with an entity 610 (comprising a user agent 1230 or other client device 200 as described in FIGS. 1, 7, 11-13, e.g.). Likewise the one or more servers 300 may communicate with a second entity 620.

As shown, server 300B includes (in a memory 304 or other storage medium 318 thereof, e.g.) at least a short-term service public key 631 paired with a short-term service private key 632, a long-term service public key 441 paired with a long-term service private key 442, one or more determinations 644 as described below, one or more client public keys 611B, authority information 646 (describing at least one of the one or more authorities), and one or more modules 645 (as components of special-purpose circuitry 322, e.g.). An authority 405A trusted at least by server 300B may be implemented as a Network Owner (that owns at least network 602, e.g.) having a network owner public key 681 paired with a network owner private key 682.

As shown entity 610 includes (in a memory 204 or other storage medium 218 thereof, e.g.) one or more instances of a user public key 601 paired with a corresponding user private key 602 (for long term use over the course of months or more, e.g.), of a client public key 611A (identical to client public key 611B) paired with a corresponding client private key 612 (for short term use during a single session, e.g.), a service locator record 614, authority info 616 (describing at least one of the one or more authorities 405), an identity record 617, and a session key 618. Entity 610 may trust an authority 405B of its own or may be configured to use authority 405A (as a shared authority). A signal 667 from entity 610 may include one or more such data items as described below. As shown entity 620 may have one or more instances of identity records 627 or of session keys 628 because of which entity 620 is a security risk. In some variants, suitable security protocols are described such that entity 610 receives a signal 668 in reply to a proper request and that entity 620 receives no reply whatsoever to a superficially similar request.

FIG. 7 includes an example network 700 and shows some of the major components of systems described herein. At the highest level, a number of user agents (at item 1230 and at item 1231) want to connect to a variety of services (at item 1291 through at item 1294 and at item 1299). In this example, the Network Owner (implemented as user agent 1230, e.g.) creates a COI at item 1220 or group of resources and then invites or adds the Member Users at item 1231 and services (at item 1282, at item 1283, at item 1291 through at item 1294) to the COI. Components of the technology handle all the key management to allow fully encrypted end-to-end connectivity between all participants (user agents to user agents, services to services, users to services, etc.), that provides stronger security, better performance, and management points for critical organizational needs.

### Architecture and Basic Usage

Referring to FIG. 7, in a basic scenario a user agent (i.e. at item 1230, at item 1231, etc.) becomes a Network Owner (implemented as user agent 1230, e.g.), creates a community of interest (COI) at item 1220, and adds a service to the COI. Additional users of the COI can be added as members. This creation can be done dynamically allowing COIs to be created instantly by individual users of the network or under a planned organizational structure. At a fundamental level the communication within the system is based on a public/private key pairs (discussed below; where every end-point has an associated key (at one or more instances of item 1230, of item 1231, of item 1282, of item 1283, or of items 1291-1294). In this scenario, the Network Owner controls membership and service inclusion in a COI, manages key rotations, and distributes information including invitation messages, service listings, user certificates, etc. to members and to services to allow communication from user agents to services. Each user agent provides its own key creation, storage, and management functions, manages the COI listings it belongs to as a member, and manages communication to other participants within the network (i.e. key exchanges, receipt of invitations from network owner, general communication with services, etc.). To assist in managing the key and information distribution (i.e. how clients of the system find out about other keys) one or more preferred embodiments uses a variety of information servers. The Messaging Server at item 1211 allows directed messages to be sent between clients and allows user agents to lookup keys based on user profile information (like e-mail address or phone number). The Encrypted Information Server (EIS) at item 1210 allows information, potentially encrypted information, to be queried across the network. In some embodiments the functionality of the Messaging Server and EIS could be combined into a single server or distributed across a hierarchy of different servers.

When a Network Owner configures a COI, several components can be used to assist in setting up the included services and member users. The first is a Service Provider at item 1203, which provides a list of services that can be attached. The Service Provider could offer services on the local organization network (i.e. at items 1291-1293), which may be on a single device or across multiple devices; services started on a Cloud network at item 1294; or third party services, which are not managed by the organization. Each service may be configured from the Network Owner with a set of policy requirements, which might include logging data, authentication, etc. In embodiments where the communication protocol requires authentication, the authentication can be directed to a specific Authenticator at item 1202, thereby ensuring that users are authenticated by external resources (i.e. LDAP or SAML) or by additional factors (i.e. face recognition or fingerprint) prior to access. When adding User Members to a COI the Network Owner can individually invite users or can specify a Validator at item 1201 where any user profile that has a particular attribute, verified with a cryptographic certificate issued by a trusted party, can join the COI. These Architectural Control Points (i.e. Validators, Authenticators, Policy Specifications) allow the COI to be dynamically created while allowing an organization to maintain a similar level of control to what is typical in traditional networks.

In one or more preferred embodiments, once the keys, policies, and service locations for the system have been distributed, communications may be established using a secure protocol, such as the SPProtocol at item 1280. The SPProtocol not only provides encryption of the communication channel, it also uses keying information prior to connection acceptance to automatically provide key based authentication and access control. In addition, the SPProtocol may provide several performance improvements and additional security improvements including support for detailed and traceable auditing of every packet back to a specific user agent. Organizations which then use the cryptographic identities (approved through validators or by the Network Owner knowledge) for all connections can then trace to a specific User Profile every packet and data block on the network. Unlike traditional IP protocols, which cannot be accurately traced to a user login or device; attacks, fraud, or misuse of the network can be accurately tied to a user agent and handled accordingly.

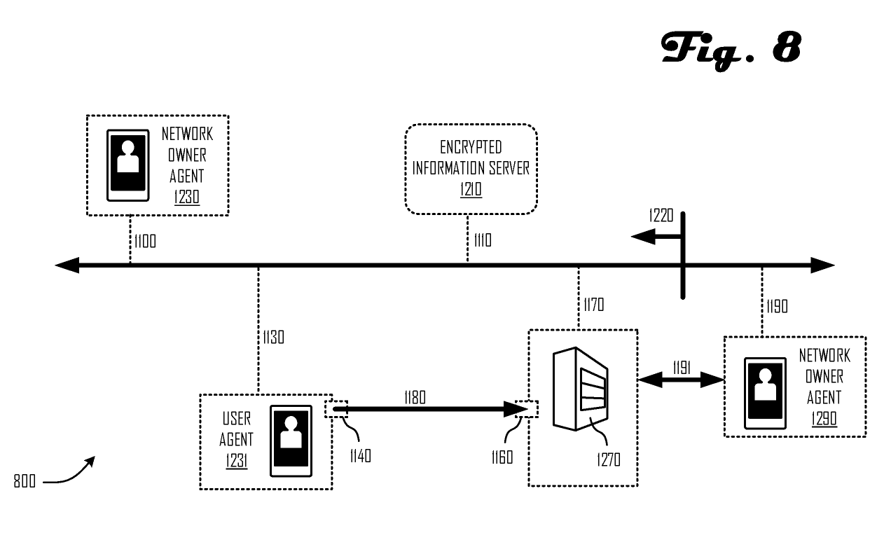

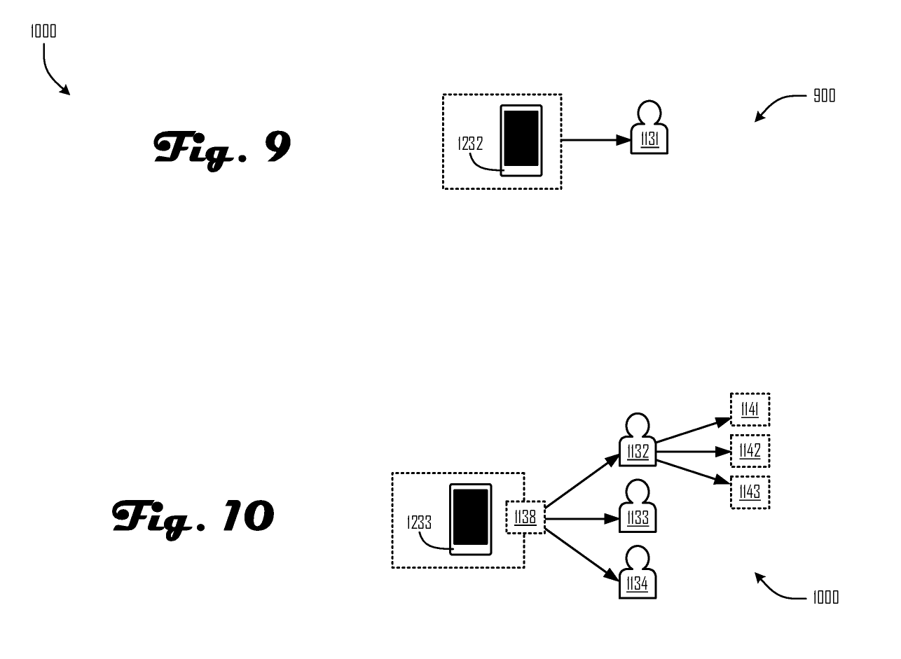

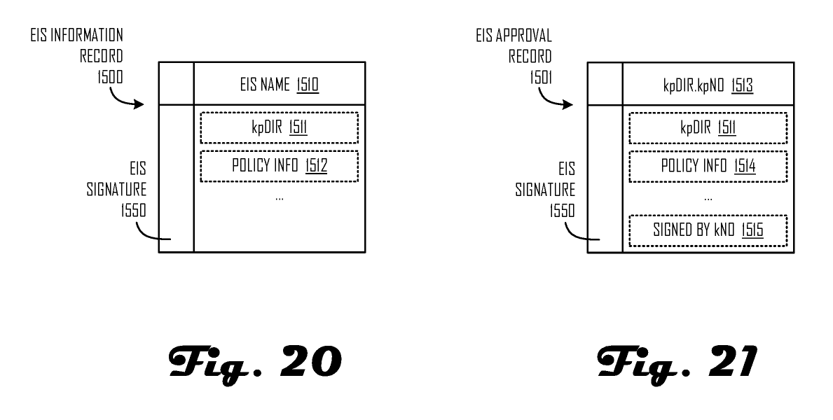

In one or more preferred embodiments, an EIS (at item 1210, e.g.) offers data blocks for services and user agents to validate each other (See FIG. 20) per the COI participants described in FIG. 8. In many workable variants, one or more of these specific records are modified or omitted from the examples provided.

### Single Root of Trust with Shared Control Points

In one or more preferred embodiments, the Network Owner (implemented as user agent 1230, e.g.) for a COI at item 1220 controls both who is a member of the COI and which services are included in the COI. This information is then distributed through an Encrypted Information Server (i.e. EIS at item 1210) that can disseminate information, but is not trusted with knowledge about the information being exchanged or given the ability to change the information. The Network Owner (implemented as user agent 1230, e.g.) also delegates specific controls to other parties including:
Services (i.e. at item 1270) within the COI at item 1220 are responsible for posting and managing how users within the COI can connect to them. Services post the connection information to the EIS at item 1210 as part of a service record (i.e. FIG. 20 at item 1503 or at item 1504) and may allow the EIS or other servers to assist in tunneling traffic around network issues (network address translation, etc.).
Authentication. Although all SPProtocol connections and EIS usage typically require every User Member to be specifically invited to the COI, the services as specified by the Network Owner may require additional or different authentication, for example that received from an Authenticator at item 1202. This might include recent authentication tickets, LDAP authentication, a second person in the COI to agree to the connection, or any type of other authentication.
Validators at item 1201. The Network Owner or a third party validation service accessed through a validator may import lists of members from other sources (LDAP or SAML) and give users tokens (i.e. signed certificates) showing a user identity meets a certain property. The Network Owner may then use the existence of a token as the basis for a COI membership.
The key management and communication allows a distributed control model, and yet, brings all security back to a single point or root of trust for each COI: the Network Owner (implemented as user agent 1230, e.g.) or console. One or more preferred embodiments maintains a singular point of trust for each COI, generally with the Network Owner. For example, validated tokens have to be specifically approved for use in a COI by the Network Owner. This singular root of trust concept is kept throughout the COI such that the EIS server, all services within the COI, all members, etc. are all approved by the Network Owner, Additional information, for example the service location, which can be managed by the service itself, is then signed by keying material that the Network Owner has approved (i.e the kLY key). This is significantly different from traditional models, which may use third party generated certificates to create trust chains.

While a Network Owner could manage an entire organization, one benefit over traditional systems is that any user agent on the network can become a Network Owner allowing distributed control of resources, distributing risk across different administrative or user agent groups within the network, allowing localized control of isolated resources, and allowing multiple organizations or users from different network domains to use resources no matter the physical location of the resource. Combined with a single chain of trust which flows from the Network Owner a much higher security level can be maintained.

### Participants and Their Public Keys used for Identity Tokens

Communication within the system is based on public/private key pairs. The discussed technology uses keys (public portion) for identity and discovery, separating off how to reach a particular service, user agent, Network Owner, or other COI participants into queries done through various information services.

Throughout this description, public/private key pairs are designated by kX. If only the public portion of the key is used then it will be designated as kpX. In addition to public/private key pairs, the invention also uses a number of symmetric keys that are typically used for encrypting specific communication payloads, of particular note are the session keys (skSession at item 1180) used to encrypt the actual data going over a network channel. These symmetric keys are typically keying material exchanged or negotiated though common key exchange methods (like Diffie-Hellman) with the other party.

Referring again to FIG. 8, the main participants and their public keys within the network are:
Network Owner (implemented as user agent 1230, e.g.)—kNO at item 1100—The Network Owner key (kNO) could be managed through a traditional management console where a single network owner station manages all the services on an entire network or controlled by a user agent which manages a small subset of services on the network. Certain embodiments allow a multitude of kNOs, one for each COI created, while in other embodiments the kNO may be the same across multiple COIs.
User Contact Key—kUser at item 1130—Each COI participant (user agent or service) uses their own public/private key as they join the COI. This key is used to communicate to other participants. It acts as the primary identification for the Client Agent. Client agents could be anything that needs to communicate with other organizational resources including services that talk to other services (i.e. web server talks to a database server) or automated devices (i.e. Internet of Thing device, thermostat, etc.) that need to communicate with other devices or a management server.
User Network Membership Key—kNM at item 1140—When a user or client agent is added to the COI, the kNM is used to both communicate the invitation and is the key approved for connectivity. The kNM may be signed by the kUser key to maintain the relationship between client agents and membership identity. Referring again to FIG. 10, in some embodiments the kNM may be the same as the kUser key at item 1131 or the membership keys would be different for every COI at item 1141 through at item 1143.
Long Term Service Key—kLT at item 1170—Services offered on the network, which use the SPProtocol or something similar, use a long term public key as the primary keying material and identification. The kLT in many cases becomes the identity of the service and is used to lookup location information as well as to enable secure communication.
Short Term Service Key—kST at item 1160—Services need to be able to quickly roll keys to provide stronger security. The kST acts as the current communication key for establishing a connection to a service. In some embodiments, with a loss of some security benefits (i.e. inability to perform regular key rotations at the service), the kST may equal the kLT.
Network View Key—kNView at item 1120—A group key used by all members of a COI to share information within the COI as a group. In one or more preferred embodiments, all user member agents are given the private portion of the kNView key and services are just given the public portion. In another embodiment, with a loss of some security benefits (i.e. the services within a COI can view private COI information), this could be a symmetric key or all participants might receive the private portion of the kNView key.
Directory Service Key—kDir at item 1110—The directory service (discussed below in the EIS section) also uses its own identity key, which is used to ensure the EIS used by the Network Owner is also used by the Client Agents.
Machine Owner—kMO at item 1190—in some configurations it is beneficial to have a separate Machine Owner which configures the policy of a specific server or cluster of servers including which services can be offered, firewall rules, logging information, etc. The Machine Owner Agent may be the same as the Network Owner Agent, a secondary user agent, or may be a third party, which just handles administrative needs. The key, kMO, used to manage the server could be the same as the kNO key or they could be unique.
Client side session public/private key—kClient at item 1150—for connections when using the SPProtocol or some similar key based protocol, client agents make a public/private key pair which is just for the purposes of connecting to a service. This key typically exists only for the duration of the session and is used to generate sessions keys as needed skSession at item 1180 (key rolling during a session will cause multiple skSession keys to be used).

Every participant within the COI may create their own unique public/private key pairs for identification, validation, and communication purposes. In other embodiments, the keys could be handed out to participants from a central key authority. For some embodiments ed25519 public/private key pairs are used as the number of bytes needed to transmit the public key is small. However, any type of public/private keying system which supports the relevant types of operations (signing, session or temporary key exchange, etc.) could be used instead. The public key is then used to identify a participant on the network. This allows routing, authentication, and trusted information to be built on a unique identity tokens (the public keys) within the network. Participants on the network may use unique keys per function, as described herein where the kUser key is different than the kNO key, or participants could use the same key pair for all functions within an end point software, for example a user agent may use the same key for all functions (i.e. kUser, kMO, kNO, and kNM).

Where information is encrypted to a public/private key pair a number of different methods may be used in practice. For example, a symmetric key may be negotiated between the two parties and then used to send the information or a unique nonce may be used to send data between the two keys. The specific embodiment used to send information to a private key pair does not impact the overall technology as long as the method maintains the secrecy of the data transmitted.

Most organizations will have numerous user agents (at item 1230, at item 1231), services (at item 1270, at item 1271, at items 1291-1294) and COIs at item 1120 across the organization; but for the purposes of this paper typically a single user agent to a single service will be used for examples.

Communication between network participants (user agents, Network Owner, services, etc.) typically flows through the EIS server at item 1210 or a messaging server at item 1211. For the purposes of this description, the EIS server manages continuous communication needs (the current location of a service, the current user membership certificate, etc.) whereas the messaging service typically handles single event messages (i.e. invitation messages, key lookups, etc.). However, different messaging architectures could be used to exchange the data between participants.

Referring again to FIG. 10 by way of example, in accordance with some embodiments, user agents may create a number of contact keys for different roles within an organization or between organizations. For a complex example (see FIG. 10), a user agent may have a key that represents their employee role at item 1132 and a different key for their personal role at item 1133. Different contact keys for specific roles allow policy and actions to vary by COI without overlap in keying material and when combined with validators can be used directly to provide role based access. COI membership keys may then be different for each role and COI, or may match the role key. In an embodiment where users have multiple keys with different roles the user contact keys may exist as completely separate identities or could exist within a hierarchy signed by a User Master key at item 1138. For example, Alice signs and verifies each role (i.e. Alice the Developer, and Alice the Mom). The complexity of the contact key structure could be tailored based on the needs of organizations to maintain separation between roles and keys; in addition, some organizations may prefer to assign permissions to the role rather than the user. Many variations between the simple and complex examples could be used in various embodiments.

### Encrypted Information Server (EIS)

Techniques described herein provide a computer-implemented method to share secure information over an untrusted communication medium while providing integrity and validity of the data. An information server accepts signed encrypted data, without knowing what the data contains, and hands out the data to any requesting party in a reliable manner The EIS (Encrypted Information Server) structures information in such a way that requesting parties can easily find the information they are looking for, and yet, provided information can be verified for a first level of integrity before being stored.

The system includes an Encrypted Information Server (EIS) at item 1210 that offers signed and often encrypted data blocks to requesting users. The EIS may provide additional management and accounting functions including a) managing how long records last (time to live), b) auditing for accounting and reliability purposes (i.e. by assigning the kpNO to a specific user account and then tracking all records signed by the kNO all record can be attached to the user account), c) billing, or d) acting as a STUN (Session Traversal of UDP protocol through network translators) server to assist client-to-service communication. The EIS could be a single machine (virtual or physical) or reside across a cluster of machines. The EIS information could reside on a single machine, such that all information would be looked up at a single location, or the EIS information might exist as a hierarchy across a set of servers where the information requested would be specific to a particular server. In some variants the EIS is built on top of a Directory Name Server (DNS) architecture, but the EIS could be built upon any type of informational server (web, specialized protocol, publish/subscribe model, etc.). In other embodiments the EIS may have multiple interfaces for example one through DNS type queries and one through secure web queries. Although secure web queries provide some security upgrades over traditional DNS, the performance and hierarchical structures inherent in DNS are beneficial. The described embodiments improve the security of traditional DNS protocols and could be used as a stand-alone security upgrade.

The purpose of the EIS is to disseminate information about secure services in a method that protects against misuse and misinformation, thereby preventing a number of categories of attack including many types of DoS, Man-in-the-middle routing attacks, etc. At a low level the EIS serves up encrypted data blocks, but it also provides a level of validation to the blocks before they are stored helping prevent dissemination of bad data. The EIS could be implemented as a pushed message system where each block of information is delivered directly to the participants as it is received or, as in the example embodiment, the EIS is a server that gives out the latest information on request.

The ideal security posture is to create a single trust relationship, ideally between the Network Owner and any member users and services. The purpose of the architecture is to create a trust model where no trust is placed in any external resources without Network Owner approval. To achieve this, every piece of critical information is signed directly by the kNO at item 1100 or flows directly from trust given by the Network Owner (implemented as user agent 1230, e.g.). For example, once a service has been deemed trusted by the kNO at item 1100, usually via a user invitation or other message, the service (i.e. at item 1270) within the COI at item 1220 can sign their own records with the kLT at item 1170 service key. In other embodiments, the trust relationship trying to be achieved may be different and therefore the types of records and specific signing details might be modified.

Lookups within the EIS are done on one of three models 1) lookup a name for information about that participant (e.g. at item 1500 or with a key at item 1507), 2) lookup a key (i.e. .kpY e.g. at item 1508, at item 1503, or at item 1505) to get an information record from the identity (e.g. service agent) that owns that key, or 3) lookup a key tuple kpX.kpY to get an information record destined for kpX from kpY. The order of the tuple kpX verus kpY first does not matter for security reasons as long as it is consistent across the information server and clients.

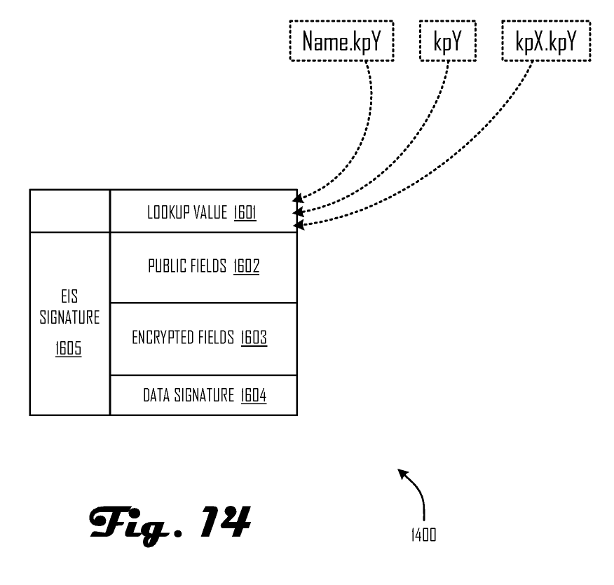

In one or more preferred embodiments, the lookup structure is constricted such that the last name item (i.e. kpY) in the lookup of any record (i.e. kpX.kpY or .kpY) is used for signing the record. This means that even though the EIS has no knowledge of what records are used for which types of information, the EIS can still verify that the record has been signed by the appropriate key. (See FIG. 14) The data blocks submitted for a record at item 1602 and at item 1603 are signed by the key (kY) submitting the record. The signature is then included in the submission at item 1604 and stored with the record to allow querying agents to also verify the signature. Additionally each record returned from the EIS server is signed at item 1605 by the EIS key kDir as well. This signature also covers the nonce (see below) that is submitted by the client when a request is made.

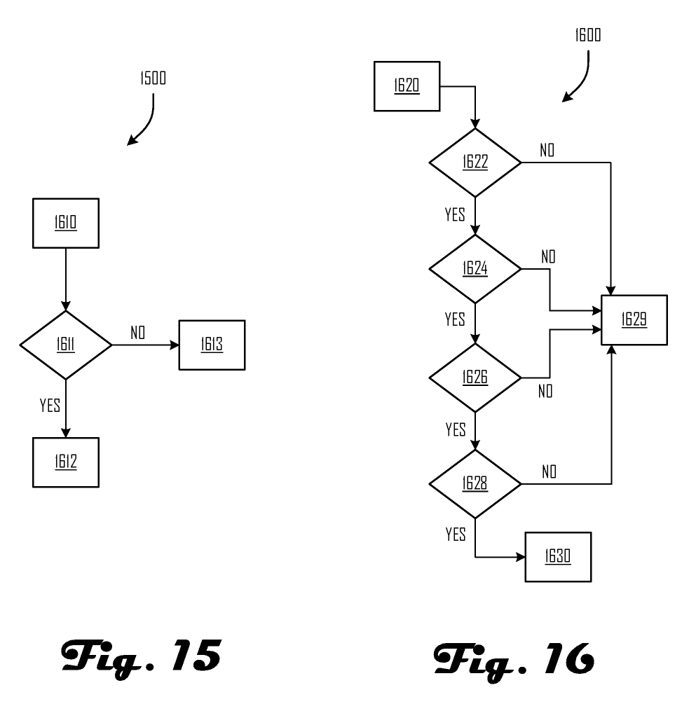

Referring to flow 1500 at FIG. 15, a lookup value structure allows the EIS server to perform a simple validation on the information being written into the server, preventing attackers from submitting records for keys they do not possess. To do this, the EIS server verifies the signature block submitted in the record (by a client that submits one or more records for lookup at block 1610, e.g.) for approval at block 1604 was actually signed by the submitting kY key at block 1614. If the signature is not correct at decision block 1611, the record is rejected at block 1613. If the signature is correct the record is then stored for future queries at block 1612. In addition, the sender signature, done by kY, ensures that the EIS cannot change the records on the server without the clients notice.

In addition, since almost all records are stored under public keys, which appear to be random data, it becomes difficult for an outsider to tell what type of data is stored in the different records. Since the entire data block is encrypted and the lookup structure is the same, a user membership record at item 1504 looks similar to a machine owner policy record at item 1506.

When a client request is made to the EIS server, the requester submits a nonce (a random unique number) to the server. The EIS signs each requested record at item 1605 and the nonce with the kDir at item 1110, before sending back the response to the client. This step insures that the records cannot be replayed maliciously (send a client an out of date record thereby denying them the ability to connect). If a bad record is received, the client can detect that the record is not from the approved EIS and keep waiting to hear from the legitimate EIS server (a common race condition used for DNS attacks). This process typically relies on the client receiving the EIS Approval record at item 1501 that is signed by a trusted authority (usually the kNO at item 1100 for a COI at item 1220) to verify the EIS signature. Referring to FIG. 16, the client process to ensure a legitimate record has been received includes verifying the nonce submitted during the query was returned at item 1621, verifying the EIS signature was done by the correct EIS server at item 1623, verifying the data signature was done by the kY key at item 1625, and then successfully decrypting the record. If any one of these steps fail the record is rejected at item 1623.

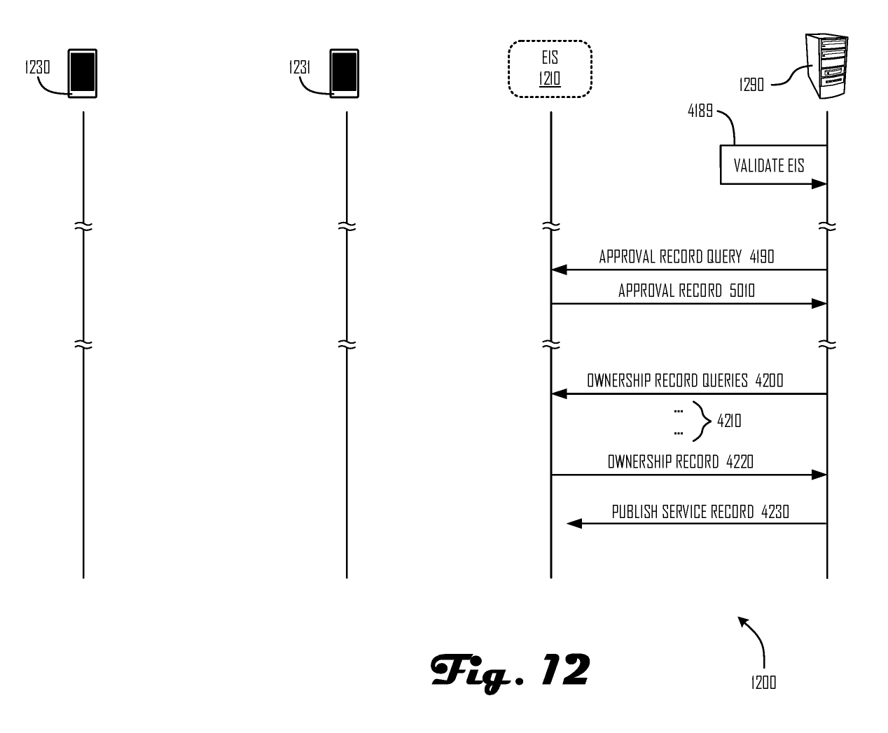

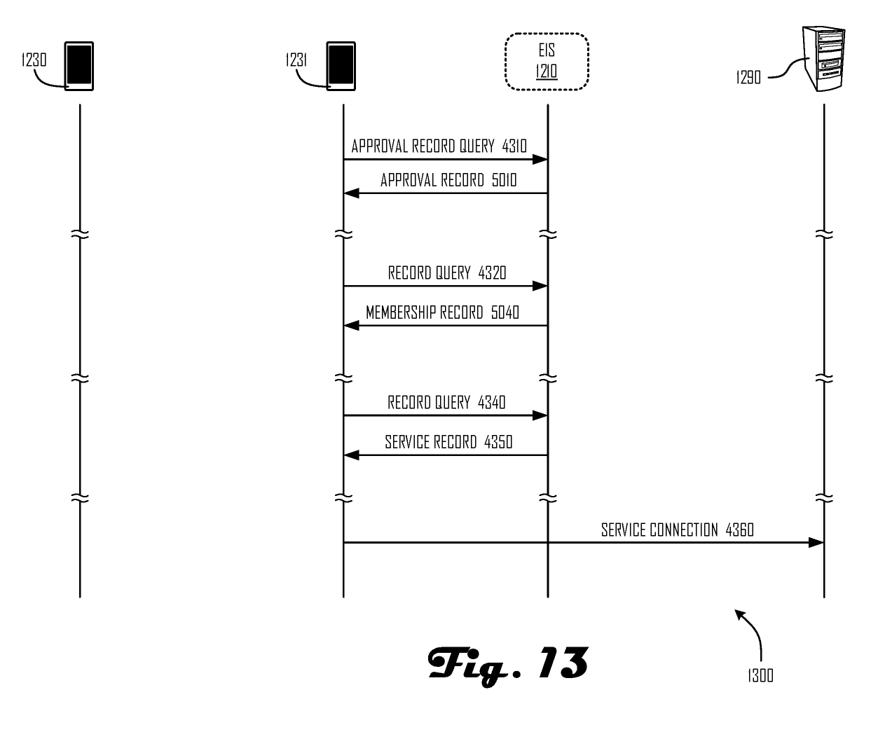

Finally, the EIS server itself (or other types of DNS servers) can be subjected to attacks including Denial of Service attacks. To help control the malicious data that can be submitted by an attacker, the nonce used to verify the integrity of records can be specially selected to force the client to perform a probabilistic number of computations, or work, prior to the submission of a query. This slows down the number of fake queries that can be generated and reduces the DoS severity. As part of this process, the query and the nonce are cryptographically hashed by the client, prior to submitting the query, and the resulting hash is checked to ensure it meets specific requirements. The requirements are typically similar to “the first X bits of the hash are zero”. Since the hash value is dependent on the nonce, by changing the value of the nonce the resulting value of the hash will change. However, since most hash functions are not predictable in the outcome (changing one bit in the nonce may change many bits in the hash), the client would need to test many nonce values to find a hash that meets the requirements. For example, in some embodiments the first 12 bits of the hash have to equal the current time of the query. The number of bits checked is directly related to the amount of work the client has to perform. For example if the first 12 bits have to be zero, the client would probabilistically need to select about 2̂11 random nonces, perform the hash, and verify the result to find a nonce that generates an acceptable hash. By making the checked value of the hash non-static (i.e. not 12 leading zeros) then a legitimate query cannot simply be resent thousands of times as part of a DoS attack, as the nonce would need be to updated as time changes. Other embodiments may use different numbers of checked bits (to change the amount of work desired) and may use a different algorithm for what the checked bits should equal (i.e. all zeros, the time, etc.) Referring to FIGS. 12 and 13 the nonce and hash need to be created until the hash matches the checked bit value desired steps at item 1660 and at item 1661 for client queries and at item 1670 and at item 1671 for records being written to the EIS server.

### Using the EIS to Protect from a DDoS or DoS Attacks

Because the EIS at item 1200 provides private, and yet, universally accessible information; it also provides a number of benefits from Denial of Service or Distributed Denial of Service attacks.

The EIS adds on top of the already existing DoS attack protections built into the SPProtocol or other DoS resistant protocols, the ability to dynamically move and adjust to network conditions including when the network is under attack from DDoS attacks (by updating a private EIS service record like that of FIG. 23 to reflect a new location as an automatic and conditional response to a detection of an attack, e.g.). When responding to DDoS attacks at item 1330 the service at item 1270 can be moved to any other network at item 1332, the service then publishes a new service record at item 1335. If the service is private, the EIS Private Service Record at item 1503 is fully encrypted preventing attackers users for being able to adjust the DDoS attack to follow the service. Without encrypting the service location, as is the case on other information services (i.e. DNS), the service cannot move without being instantly re-discovered by attackers and retargeted. Combined with the ability of the SPProtocol to remain “dark” (see later sections) to all connection attempts which are not properly approved, encrypted EIS records give a service the ability to hide from attackers and yet be available for all users across any network.

### Detailed Sample Embodiment of the Creation and Management of a COI

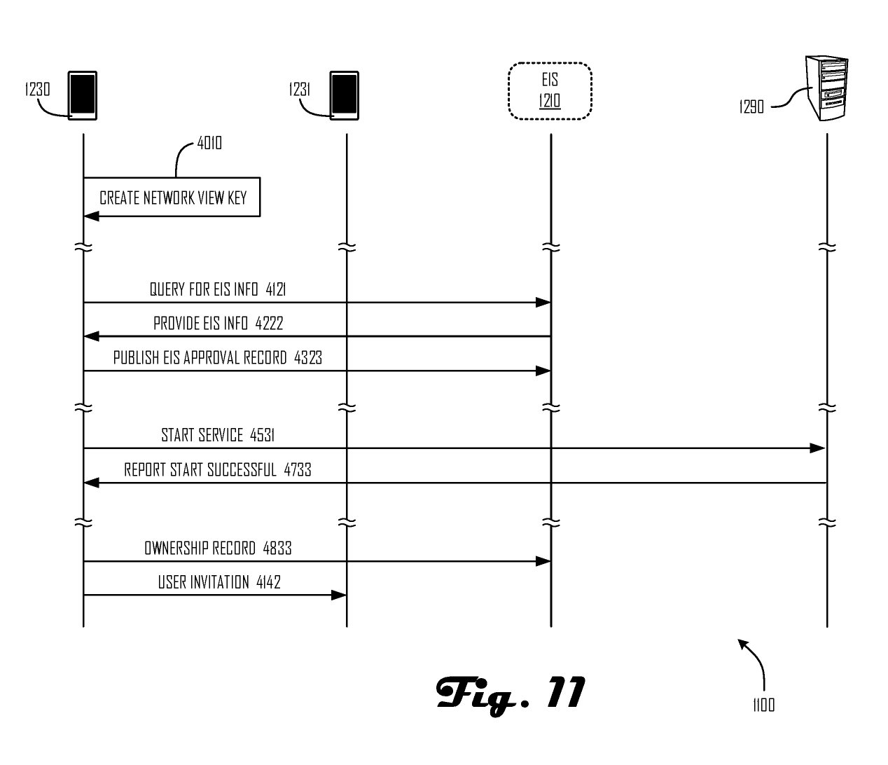

Referring to FIG. 11, before a COI is created, the Network Owner (implemented as user agent 1230, e.g.) or console may have a list of services, user members, and an EIS at item 1210 desired location. In some COI instances, the list of services and/or the list of user members may be empty. The list of services can be a list of services, which have already been started on the network (ideally with SSProtocol protections where the Network Owner already has the kLT at item 1170 keys), and/or the services list could be provided by a service provider at item 1203 and represents a list of the services that can be started by the provider. Other embodiments may include other types of service listings (i.e. public services, etc.). The Network Owner (implemented as user agent 1230, e.g.) may start with a list of potential membership keys, these are (kNM at item 1140 keys) from user agents at item 1231 that have already been exchanged with the Network Owner (implemented as user agent 1230, e.g.). In other embodiments, the list of member keys may be obtained from user agents at the time of invite, from public service directories, from private user key lists, or external validators. This exchange can happen over any process (central server, direct exchange, manual configuration, etc.). In the depicted variant, the agents exchange information through a Messaging Server at item 1211 where agents can lookup membership keys based on contact data (like e-mail address or phone number).

FIGS. 11-13 show the communication flows between the four major participants in a COI (Network Owner, a sample user agent, EIS Server, and a sample Service). Each of these parties can exist across different devices or may exist on the same device. Communication that flows directly between the Network Owner and the user agent is typically facilitated by the Messaging Server at item 1211. Once the initial configuration information is obtained the Network Owner performs the following steps in some embodiments to configure and setup a COI. Unless explicitly indicated otherwise, all steps could proceed in parallel.

1) Step at item 1400. Create the Network View key (with serial or generation numbers as needed see Key Management section), kNView at item 1120.
2) Optionally verify the EIS at item 1210 is available and publish the EIS Approval Record at item 1501 (steps at item 1401 through at item 1403). Network Owner (implemented as user agent 1230, e.g.) queries the EIS for the EIS Information Record at item 1500, signs the kpDir with the kNO at item 1200 and then posts the information back as the EIS Approval record at item 1501 under kpDir.kpNO at item 1513. The EIS and Network Owner can follow the normal EIS verification steps and creation to ensure security of the records. These steps help eliminate specific types of attacks but are not required for the COI creation.
3) For each service in the COI or when a new service is added to the COI:
a) Step at item 1404 - Is the service started? If yes proceed to step 3C, if no continue.
b) Steps at item 1405 through at item 1407. Start the service with the kpNO key, requires that the Network Owner have some management ability or permissions to start the service. In one or more preferred embodiments, all the services within the COI would need the Network Owner public key, kpNO, to add the security, isolation, and access control of the proposed protocol. The service or system running the service then returns the Service's Long Term Key public key kpLT. However, other embodiments may use other information to start the service and would receive back the needed information for clients to find and connect to the service.
c) Step at item 1408. If the service has a Long Term Key, publish a Service Ownership Record at item 1502 using kpLT.kpNO which includes the kpNView at item 1120 key and any policy or control information desired. In the background the service then monitors for the Service Ownership Record at item 1502 and then publishes its own Service Record at item 1503 (in this case a Private Service Ownership Record as a Network View Key is being used). See FIG. 12.
4) For each user agent in the COI:
a) Step at item 1410. Publish a User Membership Record at item 1504 kpNM.kpNO including the optional kNView at item 1120 key.
b) Step at item 1411. Publish or send a message to every user agent to invite them to the COI. The invitation commonly includes all the services kpLT keys, kNView key, EIS location or domain, and any policy, display, or control information for the COI. In some embodiments, the invitations could be accepted automatically by the user agents or may require approval before being accepted. In some embodiments, the user agent may respond with additional information back to the invitation including the specific User Network Membership key kpNM which should be used in the COI (Note in this embodiment the User Membership Record would be published after the invitation is accepted and the kpNM is received). In another embodiment, user agents may just monitor the EIS for new User Membership Records, using them as an automatic invitation, in this instance the User Membership Record would need to include all the invitation data.

In one or more preferred embodiments step 3C is delayed until the very end to limit the amount of unsynchronized errors when changes are made to the COI. The Service Ownership and User Membership Records can be posted in any order, however, by delaying the Service Ownership publication until the end of modifications or user agent addition there are fewer delays waiting for access while the COI is synchronized.

Once of the critical steps when starting a service is exchanging information between the Network Owner (implemented as user agent 1230, e.g.) and the Service at item 1270. In one or more preferred embodiments, at a minimum the Network Owner needs to transmit the kpNO to the Service and the service needs to send back the kpLT. Since the public keys are relatively long and consist of essentially random looking data, it is difficult for users to manually enter the information. There are multiple ways to automate or make this exchange simpler; for example, by the user agent selecting a lookup id, which is easy to type and relatively short, and entering the lookup id into both the Network Owner and the Service. The lookup id is then used to exchange information through something like the EIS server, a messaging system or other exchange. Alternate methods might include scanning a bar code, entering an IP-address and port the service will listen on, etc. One or more preferred embodiments would support multiple methods to allow for exchanges in different types of configurations.

FIG. 12 includes a more detailed process of the communication that occurs between the service being started (FIG. 6 step at item 1405) and the Service Record being published which is needed for a user agent to connect to the service.
Steps at item 1418 and at item 1419. Optionally verify the EIS at item 1210. The service at item 1200 queries the EIS for the EIS Information Record at item 1500.
Steps at items 1420-1422. Monitors the EIS for the Service Ownership Record. This typically is done my regularly sending queries for the Service Ownership Record or polling the server until a valid result is returned. The service can verify the validity of the record using the normal EIS client query process (See FIG. 11).
Steps at item 1423. For as long as the service is active continue to publish the Service Record. The record can be republished regularly (for example every five minutes) and would contain all the information needed for a client to access the service including location data, etc.

### Detailed Sample Embodiment for Changes to a COI

When a user agent is deleted from the COI (assuming the Network Owner wants to keep perfect-forwards-secrecy):
Create a new Network View Key (See Key Rotation Management) in one embodiment by increasing the serial number: kNView+1.
For each service in the COI
   Publish a new Service Ownership Record at item 1502 that now includes the new Network View Key kNView+1.
For each user agent remaining in the COI
   Publish a new User Membership Record at item 1504 including the new Network View Key kNView+1.

When a user agent is added to the COI:
If Perfect-backwards-secrecy is desired then:
   Create a new Network View Key, in one embodiment by increasing the generation number and then follow the steps to create the first serial number (kNView gen+1).
   For each service in the COI
      Publish a new Service Ownership Record at item 1502 that now includes the new Network View Key kNView gen +1.
   For each user agent:
      Publish a new User Membership Record at item 1504 including the new (kNView gen+1) key.
      Send each user agent a new invitation to the COI.
If perfect-backwards-secrecy is not required:
   For the new user agent publish a new User Membership Record at item 1504 with the existing kNView key.
   Send the new user agent an invitation to the COI.

When a service is added to the COI follow steps 3 from the initial COI start up (FIG. 6 steps at item 1404 through at item 1408) and then send new user invitation messages updating all the user agents with the new service information.

When a service is deleted from the COI:
Stop the service if needed or desired.
For each user agent in the COI:
   Publish or send a message to every user client that updates the listing of services available by removing the deleted service information.

### Detailed Sample Embodiment of a User Agent Connecting to a Service

In the sample embodiment, before connecting to a private service the user agent at item 1201 receives from the Network Owner (implemented as user agent 1230, e.g.) an invitation containing the Network Own-er public key, kpNO, COI domain (location of the EIS Server) at item 1210, an optional Network View Key kNView at item 1120, and the Service's public key kpLT (if using the SPProtocol). Referring to FIG. 13, once the initial invitation is exchanged, the user agent performs the following steps in some embodiments to connect to a service at item 1290. The queries for steps i., ii., and iii. could be requested in parallel, however if the EIS is being verified the EIS approval record at item 1501 is used to verify the User Membership Record at item 1504 and the Service Record (at item 1503 or at item 1505). In addition, the results from steps i. through iii. could be cached for different periods and only requested on the first connection attempt.
1) Steps at items 1430-1431. Optionally verify the EIS to prevent replay attacks. The user agent at item 1231 queries the EIS at item 1210 for the EIS Approval Record at item 1501, which is signed by the kNO at item 1110 from the Network Owner. In some embodiments, this step may also require querying the EIS for the EIS Information Record prior to the request for the EIS Approval Record.
2) Steps at items 1432-1433. Query the user agent's own User Membership Record at item 1504 from the EIS. This gets the user agent the certificate or other approval information needed to connect to the service. In some cases, the service may not require any authentication information, so the authentication block may be empty. In another embodiment, the User Membership Record may be part of the user invitation or it may be used in replacement of the user invitation.

3) Steps at items 1434-1435. Query the Service Record (at item 1503 or at item 1505) using the kpLT from the EIS. If there is a Network View Key this record will be encrypted to the kNView at item 1120 key.
4) Step at item 1436. Connect to the service using the method specified in the Service Record. In one or more preferred embodiments a connection using the SPProtocol is initiated but any type of connection or combination of techniques (TCP, UDP, IPSec, WiFi Direct, redirect through a relay server) could be initiated.

### Detailed Sample Embodiment of a User Agent Connecting to a Service

FIG. 20 depicts an exemplary EIS Information Record at item 1500—lookup as EIS Name at item 1510. It is a record signed by the kDir at item 1110 as part of the EIS Signature at item 1550 and not encrypted. This record includes the kpDir at item 1511 (public key of the EIS), and may include policy information at item 1512 that is requested by the organization running the EIS. Example policy information might include required Authenticator at item 1202 to be added to all COIs, organizational logging server, hash requirements for all queries, etc.

FIG. 21 depicts an exemplary EIS Approval Record at item 1501—Lookup as kpDir.kpNO at item 1515. It is a record signed by the kNO at item 1100 key and not encrypted. This record approves the EIS to act as the information server for the network owner's records. The record includes the kpDir of the EIS server and may include policy or configuration information. The EIS verifies that the record has been signed by the kNO at item 1515 before redistributing. As long as clients can easily identify the location and the second key .kpNO in the lookup name is trusted, the specific lookup location could be different. For example, in other embodiments, the EIS approval record might be placed under a different lookup key (for example kpNO.kpNO). The kpNO.kpNO lookup structure has the benefit that the client could skip the EIS information record and verify the kpDir key directly from the Approval Record.

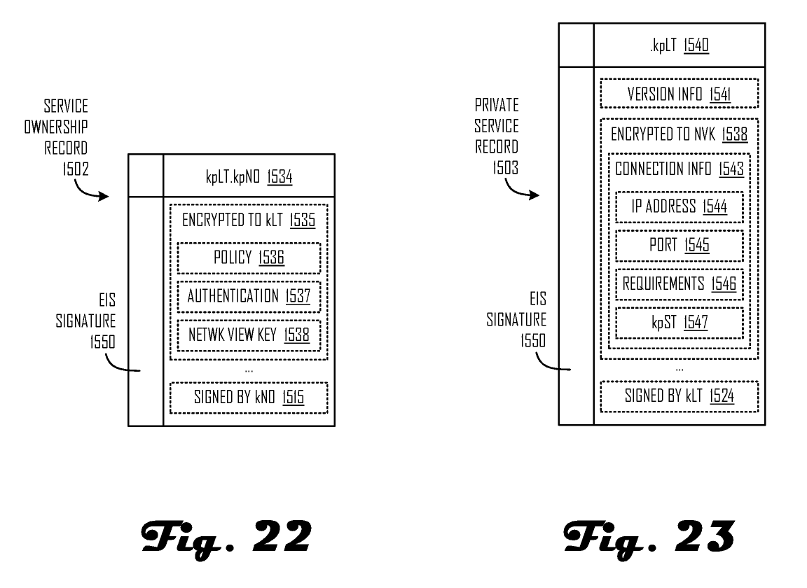

FIG. 22 depicts an exemplary Service Ownership Record at item 1502—Lookup as kpLT.kpNO at item 1534, signed by the kNO at item 1100 key, and encrypted to the kLT at item 1170. This record approves the service as designated by the kpLT to be a trusted as part of the COI at item 1220 and supplies the service policy and control information to the service. The depicted variant includes in the record an optional Network View Key (kpNView at item 1120—typically just the public portion of the key), user certificate serial numbers, auditing requirements, and policy information—for example authentication policy (i.e. user identity also needs valid LDAP credentials). The record could be extended with any amount of additional policy, control, or logging information.

FIG. 23 depicts an exemplary Private Service Record at item 1503—Lookup as kpLT at item 1540 and signed by the kLT at item 1170 service key. If the Service Ownership Record at item 1502 designated a kpNView at item 1120 key then there is an unencrypted wrapper that specifies which kNView key is required to decrypt the main contents of this record, which is encrypted to the kNView. (See key management for more information on this issue). The Service Record, which uses an encrypted data block at item 1503, allows private service location information helping prevent malicious misuse of the service record (See the DoS prevention discussion).

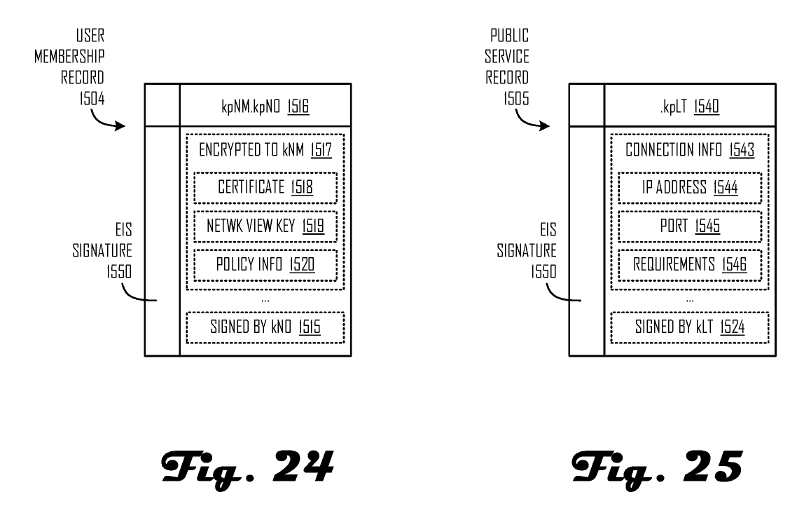

FIG. 24 depicts an exemplary User Membership Record at item 1504—Lookup as kpNM.kpNO at item 1516, signed by the kNO at item 1100 key, and encrypted to the kNM at item 1140 user key. This record gives the user agent authorization information to be a member of the COI at item 1220. It typically includes a certificate for the client agent to present to services within the COI, a copy of the Network View Key kNView at item 1120, and any client policy information that might be appropriate.

FIG. 25 depicts an exemplary Public Service Record at item 1505—Lookup as kpLT at item 1540 and signed by the kLT at item 1170 service key. If the Service Ownership Record at item 1502 designated a kpNView at item 1120 key then there is an unencrypted wrapper that specifies which kNView key is required to decrypt the main contents of this record, which is encrypted to the kNView. (See key management for more information on this issue). The Service Record, which uses an encrypted data block at item 1503, allows private service location information helping prevent malicious misuse of the service record (See the DoS prevention discussion).

If there is no kpNView key used, the service may provide more traditional public access (with or without authentication) allowing non-members of a COI to see the Service Record at item 1505. This provides functionality for where anonymous services are desired (i.e. public web site) or where the location information does not need to be secured—as the service is widely used, but still authenticated (i.e. public subscriptions—digital media sites).

Service records like those of FIGS. 23 and 25 may include all the information needed to connect to the service(s). The depicted variant includes: keying material for accessing the service (i.e. kST at item 1160 if the SPProtocol is used), IP-address/port, encryption and protocol versions, and authentication requirements. It could be extended or modified to include different control, policy, routing, or access information to support other types of connections (IPsec, etc.).

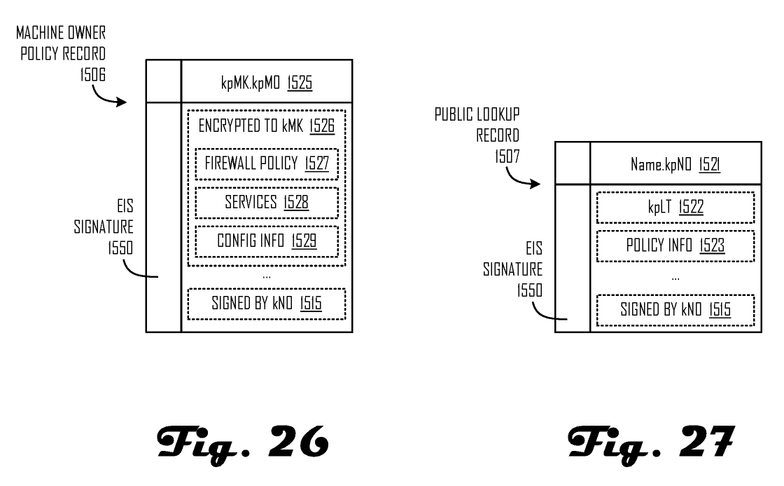

FIG. 26 depicts an exemplary Machine Owner Policy Record at item 1506—Lookup as kpMK.kpMO at item 1525, signed by the Machine Owner kMO, and encrypted to the Machine Key kMK. In some embodiments machines or servers within an organization can be managed in addition to services, the structure for the records follows the same basic outline. The Machine Owner Policy Record at item 1506 is signed by the Machine Owner Agent at item 1290 with the Machine Owner key kMO at item 1190 and posted to the Machine Key kM 1691. The record includes configuration information for the machine for example firewall policy at item 1527, services to be offered and the network owner keys kpNOs that go with them at item 1528, and potentially other security or administrative data. The machine trust model may also include an EIS approval record at kpDir.kpMO, which is signed by the Machine Owner.

FIG. 27 depicts an exemplary Public Lookup Record at item 1507—Lookup as kpNO at item 1521.

FIG. 28 depicts an exemplary Machine Record at item 1508—Lookup as kpMK at item 1530. The record encrypted to the Machine Owner key (kMO at item 1190) includes the actual configuration information used on the machine. It is signed by the kMK at item 1191 to verify it comes from the machine.

Other informational records may be used on the EIS server to exchange public or private information in a manner that can be validated to come from a specific party and used to extend a root-of-trust to other resources. For example, the Public Lookup Record at item 1507 can be used to allow services to publish an easy to remember name for long term access. One use might be when a web service needs to access a database service, the web service (which acts like a user agent) is configured with the databases simple name, dbl.org, The web service then queries the lookup record at item 1507 for dblorg.kpNO of the Network Owner, obtains the kpLT key for the database, then gets the Service Record (at item 1503 or at item 1505) for the database service, and starts a connection. For service-to-service communication needs or for permanently registered user sites (www.org) the Public Lookup Record can make connection initiation simpler.

In embodiments where additional trust is placed in the EIS, name lookup records might not be signed. For example a lookup value of “service.org” could be unsigned and unencrypted giving out a kpLT key for the service.

In one or more preferred embodiments, the EIS is used in combination with the other technology areas described to provide security from end-to-end within a network. However, by using the EIS as a stand-alone system, improvements are still made over the current state-of-the-art in terms of denial of service prevention, service cloaking, policy and control distribution, and user access controls. In other embodiments, the specific data used for access to the service (for example the kpNView key) could be exchanged with similar functioning items (for example a symmetric key) without changing the core invention. In addition, if alternate protocols were desired for accessing the service (for example IPSec), the specific access data included in the Service Record (i.e. IPSec keys) would be changed, thereby supporting a wide range of access methods. The EIS system could be used to provide trusted information for any type of information sharing. For this discussion focus has been on providing end-to-end security within a network; but it could be used to disseminate information for many other types of data (medical, financial, or other privacy records).

Although the discussion focuses on user agents to service communications, the system can also be used to support service-to-service communications or embedded system communication. In service-to-service communication cases, which are typically accessed through a client-to-server relationship, the client side communicates through a Client or User agent and the server side communicates through a Service Agent or included SDK. For embedded systems (like Internet-of-Things devices) the communication happens similarly; however, it may be desirable to change the invitation model such that the Network Owner can scan a bar code or other embedded device identification and use that information to enroll the device into a COI as either a service or as a user agent. Finally, although the most benefits are received by providing a secure service, for services that are offered to anonymous user agents (no authentication or access control required), they can still be supported in the current system by publishing unencrypted service information (at item 1507 and at item 1505), and allowing the kpLT keys offered to be attached to any COI.

Communication may also occur between two user agents, for example in a peer-to-peer model. In this configuration the user agent acts as both the initiator of the communication (as described by the client or user agent) and as a recipient of the communication (as described by the service or Service Agent). Because minimal information is needed to establish communication and no reliance on the physical network characteristics, a peer-to-peer communication model can be configured over any type of network including mesh, directed, or broadcast networks.

Finally, COIs can exist as independent and virtual overlays on any physical network with similar or dissimlar agents: COI groups can overlap users in different physical locations, a single user agent may be part of dozens of COIs or not be a member of any COI, and COIs can exist with users in different organizational hierarchies.

### Key Rotation Management

Keys are managed on the network through a collection of techniques. The simplest is when a User Contact Key at item 1130 or Network Owner key at item 1100 needs to be change or roll, they can simply sign the new key with the old key and publish a roll message. However, if the keys are lost or stolen the simple key replacement strategy is to delete the old COI or membership and rebuild the COI. The following descriptions assists when new user agents are added or removed from the COI, which may happen regularly, to make the key rotation less costly (in terms of performance and synchronization) the following technique can be used.

For group communication, the present invention uses a Network View key kNView at item 1120. Although the kNView key could be a simple public/private key or symmetric key, which is distributed to everyone within the COI, that is unique and independently created when a new version is needed, by creating some additional structures around the key the Network Owner can be more efficient with processing and reduce the amount of time the COI at item 1220 is out of synchronization (where user agents and services have different keying material), thereby increasing the amount of up time.

In one or more preferred embodiments the kNView at item 1120 key is broken up into three components:
kRootNView key—a unique and independent random key pair. This component is private to the Network Owner and not typically distributed to any other parties.
Serial Number—a sequential number created by the Network Owner.
Generation Number—a sequential number created by the Network Owner.

Using the first three components the Network Owner can derive the kNView key from a set of hashes done to the kRootNview key. This key kNView key is then specified by the tuple kNView, serial number, and generation number.

The Network Owner to create a new kNView[1,1] (i.e. with a serial number of 1 and generation number of 1) key goes through the following steps:
Create a new public/private key pair kRootNView and increment the generation number, in this case to 1.
Based on a maximum serial number variable N (hundreds or more, e.g.), the Network Owner cryptographically hashes the private key of the kRootNView N times. Any cryptographic hash operation can be used (e.g. SHA-512, MD5, etc.).

The result of the cryptographic hash is the Network View key with serial number 1, kNView[1,1]. Generically, the Network View key at a particular serial number is the hashed result from hashing the kRootNView key max-serial number+1 number of times.

This results in a series of keys, where earlier serial numbered keys can be derived from later ones (i.e. if the User agent has the key kNView[3,1] for the 3rd serial number, the agent can derive independently the second and first serial numbered keys kNView[2,1] and kNView[1,1]).

When deleting a user agent in order for future communication to remain private (i.e. provide Perfect Forward Secrecy) from the user agents just deleted, the keys need to be modified. In some embodiments to do this the Network Owner:
Increases the serial number from the present kNView tuple,
Recomputes the (kNView+new serial) key for the current serial number from the kRootNView key,
Updates the User Membership Records at item 1504 in the EIS at item 1210
Updates the Service Ownership Records at item 1502.

By updating the Service Ownership Records last the COI can continue to function while portions of the network are out of synchronization (as user agents will have both the current kNView key and can create any prior kNView keys as needed for services that have not been updated). If the User Membership Record has a serial number that is greater than the one in the Service Record, the user agent simply has to cryptographically hash the key the difference number of times (User Membership serial#—Service Record serial#). A second benefit is that all new network members can see any communications that use prior Network View keys without having to be specifically sent the entire history of keys.

When evaluating key synchronization models where all participants need to have the same key, there is a period of time where the first participant has key2 and the second participant has the old key, key1. If the keys are distributed from a centralized management console the time for complete synchronization across a large network with at item 11000s of participants can be significant. By using the discussed kNView keys with serial and generation numbers, in the most common cases where a user agent is deleted (see steps above) a user agent at item 1231 can continue to connect to a service with the old or new key until the Service Ownership Record at item 1502 is updated, meaning that the period of time the COI is not synchronized has no impact on the ability of users to connect to services on the network.

A second, but less common, property that may be desired by organizations is Perfect Backwards Secrecy, where when a new member is added to the COI they should be unable to read older messages or COI activities. This property is not as commonly used. However, some embodiments provide this functionality by increasing the Generation Number at item 1310 of the Network View Key and creating a new kRootNView at item 1315 and kNView key. This modifies the key to a value that cannot be computed from earlier keys and requires synchronization of all members before everyone can participate. The process is:
Network Owner generates new key kRootNView at item 1315, increments the generation number, and performs the hash for the maximum serial number desired.
For all previous member user agents in the COI publish User Membership records at item 1504 which include both the old generation key and the new generation key.
Publish new Service Ownership Records at item 1502 with the new generation key.
For all new users publish User Membership records at item 1504 that have only the new generation key.

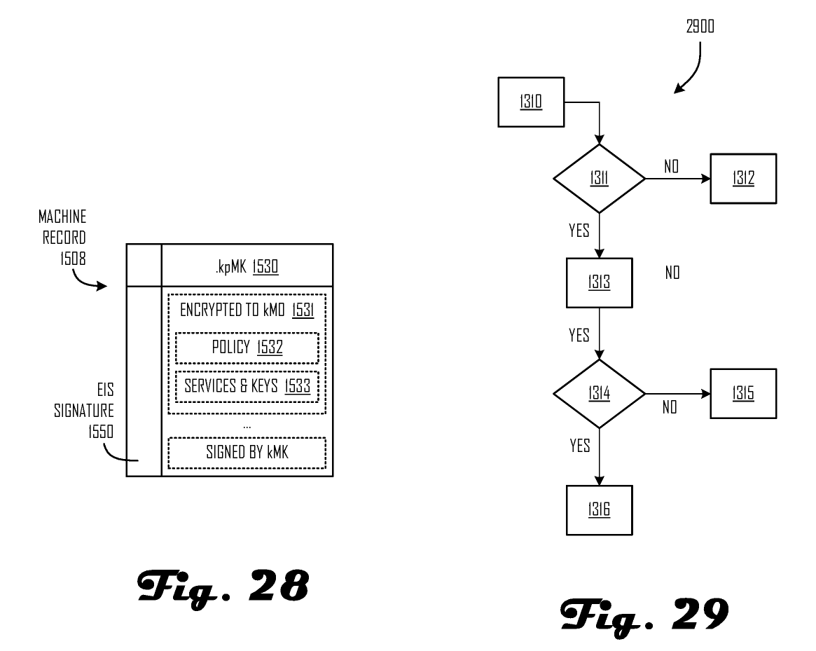

FIG. 29 depicts a full decision tree on when the serial number may be changed versus when the generation number is modified. This method allows Network Owners specific control over when they want Perfect Backwards or Prefect Forward secrecy without having the performance hit every time a member is added or removed.

### SPProtocol Service Information Dissemination, Auditing, and DoS Resistance

To make connection startups more flexible there are several methods for configuring the SPProtocol. In order to start a connection using the SPProtocol the client typically needs to have the Short Term Service key, kST at item 1160, a location for the service (typically IP-address and port), and create its own client key kClient at item 1150 that is then used to create a session key skSession (see FIG. 4 at item 1180). In the depicted variant, the service notifies clients of changes to the location through the EIS or encrypted information service. In another embodiment, if the client already has a location, the SPProtocol could be implemented such that a specialized control request to the server or to the tunnel service at that location would return the service connection information (kpST). Other means of configuring the session startup information including hard coding the kpST (limits key rotation) and location data into the client or client configuration file, or using a location ID which when entered into a messaging service would respond with the session information. Finally, in some cases, public services could be used to provide the connection data for publicly available services with some loss of security.

As the SPProtocol can provide secure communication means even in a completely disconnected network with or without a Network Owner, the protocol can be used on physically isolated networks and super localized network (e.g. blue tooth) without an increase in security risk or loss of control.

The SPProtocol implements controls to limit DoS attacks, in that it will generate puzzles that are then sent back to potential connections. In some scenarios, organizations will want to turn off this feature to provide more “dark service” benefits, as it potentially gives attackers confirmation that a service exists when they launch a DoS attack.

Even though all communication is encrypted, the SPProtocol allows external auditing of sessions across a network. When the Service Record is published, it may include an optional auditing key kpAuditing that should have access, via network sniffing or when session traffic is routed through a network gateway, to all session traffic. In one or more preferred embodiments, when the client negotiates a session key skSession between the service short term key kpST and the client's short term key kClient (typically done as a two party key agreement), the client will also negotiate a session key between kClient and the kpAuditing keys creating skAuditor. The skAuditor key is then combined with the session key skSession and including in the public packet headers. In another embodiment, if an auditing key is published, the session key being used (i.e. skSession) is encrypted to the auditing key (i.e. kpAuditing) such that it can only be read by the auditor and then included in public packet headers of the session. The encrypted session key (or combined skAuditor and skSession key) may be included in just the tunnel creation packets or, in other embodiments, may be included in every packet. Once the session key is received by the auditor, the auditor can view all the data within the session including the authentication used by the client and any user profile or user identity information. Finally, it is beneficial to include the service's long term public key kpLT in the tunnel creation data to assist the auditor in keeping track of the tunnel identity. The auditor could then monitor for malicious use, enforce policy decisions, or otherwise control the session from a network gateway, through network traffic manipulation, or through out-of-band techniques to the service itself.

### First Packet Data and Dark Services

SPProtocol supports first packet data and authentication, thereby allowing faster start up times and reducing the round trips required to communicate (which is the main cause of slow connections on high latency networks). The SPProtocol's first packet authentication also increases the security of the service by eliminating any communication with the underlying service protocol (i.e. http) until the request has been authenticated and creates a “dark service” that is hidden from the network. First packet authentication, where the very first packet within a connecting includes the full authentication information, insures that prior to any processing being done on the data within the connection that the client is fully authenticated and authorized to send data. “The SPProtocol, by combining first packet authentication with an encrypted channel that uses any form of authenticated encryption (provides confidentiality, integrity, and authenticity assurances), ensures that every packet within a communication channel becomes traceable to the user credentials used in the first packet. Unlike other protocols that just validate the single packet with authentication in it, the SPProtocol allows every packet to be authenticated to specific user credentials. The SPProtocol also allows first packet data within a connection startup further reducing the number of round trips before useful communication occurs.

The SPProtocol supports dark services with two main methods: the first is that under most error cases (i.e. bad authentication, wrong communication key, badly formatted packet) no error messages are sent back to the client. To attackers trying to probe the network it becomes difficult without proper authentication credentials to create a packet that will generate any type of response, thereby making it difficult to even identify that the service exists. Technical support, including network connectivity issues, can be handled out-of-band with errors sent directly to administrators. The second control that makes dark services possible is that the information required to connect, specifically the Service Short Term Key kpST, is not publicly available, as the COI and EIS combine to allow the kpST to be encrypted and accessible only to those members who are approved. These techniques combine to create services which are hidden from access, dark, and limit the types of successful attacks which can be launched.

When the SPProtocol is implemented directly by clients and services there are no tunnel modifications required; however, to support existing (non-SPProtocol enabled) services or clients, tunneling agents can be used to reduce round trip times over wide area networks. There are two main locations of a connection tunnel that require modification in order to support first packet data payloads for stateful connections. The first is at the client side, traditionally a client will request a connection then, if successful, they will send authentication information and then the first packet of data. Each step has to be done in order and may generate multiple round trips of packets. Because of this lock step process, the client tunnel does not have access to the data to be sent until after the connection is accepted. The depicted variant of the invention uses a predictive and adaptive acceptance model to decide if the client can start sending data early. This allows the client to act under the traditional connection model, with minimal modification while still reducing the round trips

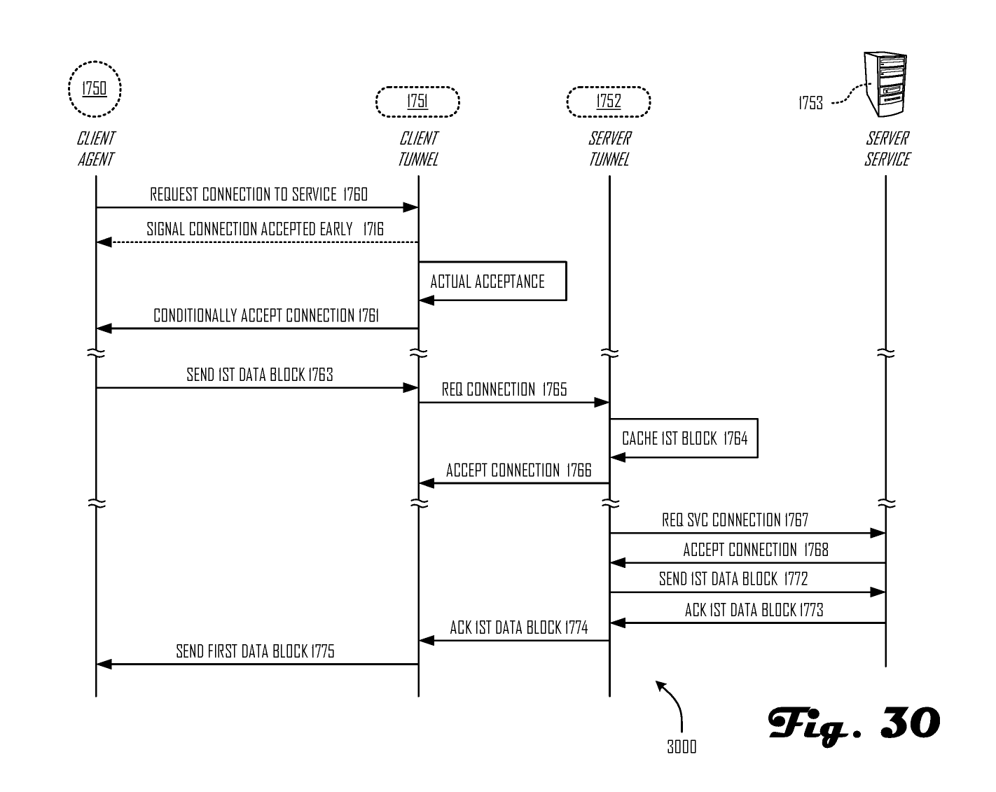

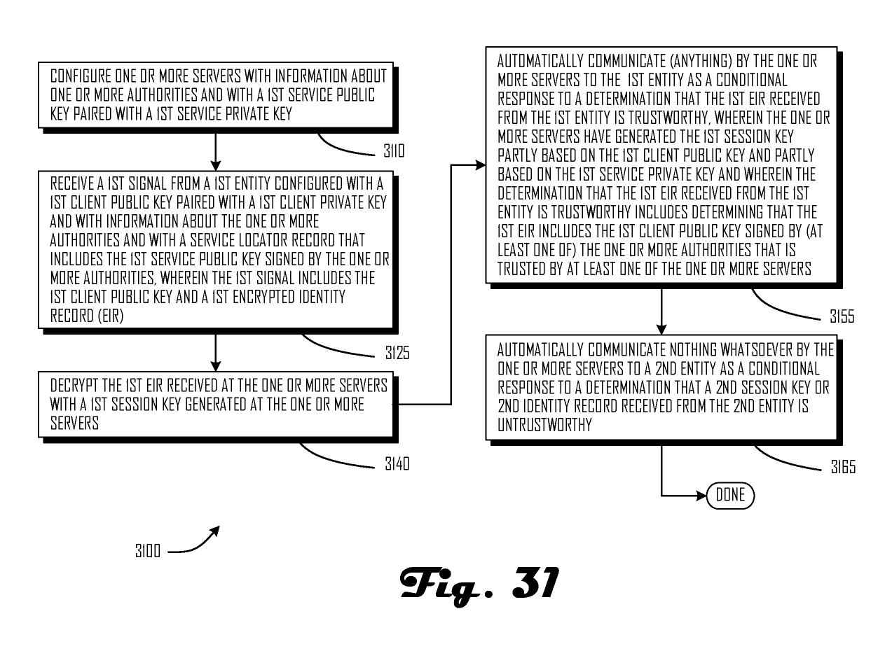

FIG. 30 depicts another programmatic event sequence as a data flow 3000 in accordance with one or more embodiments.
Step at item 1760. Client Agent at item 1750 requests a connection to a service.
Step at item 1761. Client Tunnel at item 1751 predicatively accepts the connection. If the client tunnel does not expect the connection to be accepted, it will wait until the tunnel connection is actually accepted before signaling to the Client Agent connection acceptance. In this instance, no data is sent with the connection request and the process proceeds along traditional models. However, if the tunnel determines it is likely the connection will be accepted and first packet data would be beneficial, it will signal connection accepted to the client at item 1716 early.
Step at item 1763. After getting service routing information (DNS, etc.) if needed, client agent 1750 gets acceptance notification and sends on the first block of data. In the example embodiment the data is limited to a specific size (ideally what will fit within the first packet, or the size of the cache on the client side of the tunnel). In some instances, depending on the timing of step at item 1763 since it is independent of the actions by the tunnel, the data will arrive after the connection start up step at item 1765 has already been sent, preventing the data from being included in the first packet.
The tunnel caches the first block of data at item 1764, then starts the connection start-up process.
   Step at item 1762. This step can start at any point after step at item 1760 is received. Query the DNS for the location of the service (in the example embodiment this is the Service Record from an EIS).
   Step at item 1765. Start a connection to the service. In the example embodiment, the SPProtocol is used, and the first packet includes the authenticators needed for the connection and the cached first data block.

The predictive acceptance model in some embodiments is currently based primarily on if previous connections have been successful at item 1701 and it may respond to the client agent at any point in the connection start-up process. In the sample process embodiment the main decision points on if the connection can be predictively accepted, rather than waiting for the connection to traditionally accepted by the sever are: at item 1701 Has the service been successfully contacted recently, at item 1702 Does the user agent have current credentials, or at item 1703 will first data processing be helpful. In other embodiments, the predictive model could be simpler (always accept the client connection request immediately and just work around the behavior issues of closing a connection mid-stream without being able to signal how much data was lost to the client) or more complex at item 1711 based on network topologies, latency or bandwidth of the network, service location, type of authentication required, network conditions, or any other external or internal to the connection factors.

Assuming the service being offered over the network does not natively speak the SPProtocol, then the following process is used on the service side of the tunnel to process and control the first packet data.
Step at item 1766. The Server Tunnel at item 1752 receives the first packet, after validating the encryption, authentication, and any other type of controls requires for secure processing. It caches the first data block included in the first packet. If validation fails it may send back a rejection message or simply throw away the connection.
Steps at item 1767 through at item 1771. The server tunnel then contacts the service over traditional protocols and requests a connection. The connection process could be a simple normal syn/syn, ack/syn, ack or it could include more complex start up options including submitting single sign on authentication credentials or any other type of authentication and control data to form the connection.
Steps at item 1772 through at item 1774. If the connection is accepted the service tunnel then sends the cached first packet and responds to the client side of the tunnel that the connection has been accepted and the data block has been transmitted. In some embodiments, the server tunnel may wait for the first data to be received back from the server before accepting the connection, to allow sending back a response simultaneously.

If the client or server agent is integrated with SPProtocol directly, the need for some predictive behaviors (where the connection exists in a partially formed state) and caching requirements may be avoided and the client's control over what types of data may be included in the first packet may be improved. Other configurations may include where either the client or server side natively supports the SPProtocol, then only those portions of the process that do not have native SPProtocol support (the client to client-tunnel or server-tunnel to server) would be used. For example, if the Service uses the SPProtocol as a network library or SDK, implementing the connection directly there is no Server Tunnel used and the Service directly responds to client tunnel requests.

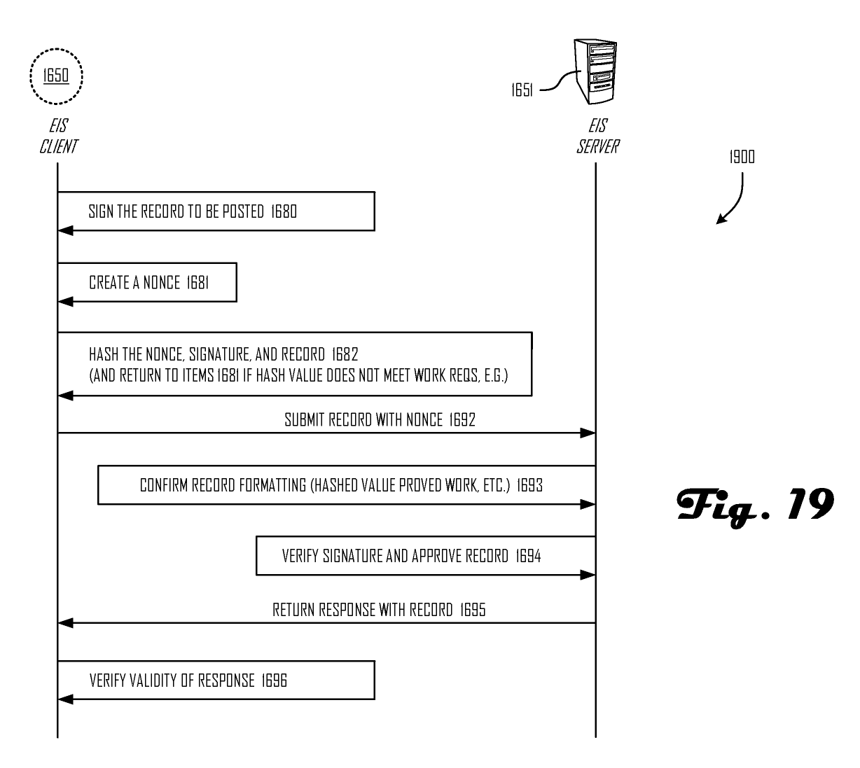

As can be visually seen in FIG. 19. a full stateful connection can be established including both authentication and first packet data in a single round trip across a high-latency network (Packets at item 1765 and at item 1774). The other round trips happen over high performance networks (typically within a single device or between physically close gateway devices) where latency is commonly not an issue. These processes can improve the perceived performance for Internet clients by several orders of magnitude.

### Mixed Connection Types and States

The SPProtocol supports multiple delivery options, including guaranteed in-order delivery to not-guaranteed and not in ordered delivery, by treating the individual data blocks within the connection independently. Since commonly every SPProtocol requires authentication, the tunnel itself may have state even while supporting individual data blocks within the tunnel being stateless. Data blocks within the tunnel are passed within a data wrapper which marks which blocks require reliable delivery.

To support guaranteed data, each guaranteed data block is saved in a re-transmit queue that is only cleared out when an acknowledgment (ACK) is received for that data block (or in certain errors cases like the connection shuts down). Blocks of data that are not guaranteed are discarded once transmitted to the other end-point. For example in one scenario an endpoint transmits a set of data blocks to another endpoint. Only those data blocks that have guaranteed delivery are saved to the re-transmission queue.

The second area of modification from traditional models (like TCP) is that the ACK system is more flexible allowing data block or transmission IDs to be ignored. Instead of an ACK message containing a single number of the last in-order message id each side of the connection has seen, it now contains a set of the messages missed since the last synchronization or ignore message. Each side then sends ignore messages at periodic intervals that tell the first side which message IDs can be ignored. For example, ignore all message IDs earlier than at item 1100. In addition to providing more flexibility, the ability to ignore packet loss in some situations allows additional benefits when transmitting common low-priority control data like acknowledgments, status queries, etc. Low priority packets can then be passed as non-guaranteed data so if the data block is lost it doesn't matter (commonly this is because the data will either be repeated later or was time sensitive and not relevant after the initial transmission window).

In addition to supporting multiple types of data delivery options, the SPProtocol extends the initial connection setup control messages to specify how data can be routed outside the tunnel after data is received. These routing options, setup by the service when it is created, can be selected by approved connections allowing extended deployment options. Referring to FIG. 7, the server side of an SPProtocol could exist in front of a single service, provide connectivity to multiple services behind a single location at item 1284 or across multiple servers at item 1283, provide connectivity to entire networks at item 1282, provide relaying services, or be built into the service directly as a library or SDK.

### Protected Internet Access

By routing communication channels based on service key kpLT and through the SPProtocol's support for extended routing options for data coming into the channel, it becomes possible to create a protected Internet pipe for mobile user devices or user agents that have to access the Internet through an untrusted source.

In some variants, one or more systems above include key and trust management components allowing participants to be cryptographically identified. These identities are then used to configure dynamic or centralized relationships between user agents and the services they can access. The embodiment for the trust management system can be easily modified to support a wide range of identity relationships no matter how simple or complex the organizational roles or rules that are desired.

In some variants, one or more systems above include an independent encrypted information server (EIS) which allows participants to quickly, and yet securely, share information across networks or even organizations. By using selective encryption and validation, the information can be shared across public servers and infrastructure without compromise while still allowing clients to verify the integrity of the data. The EIS server allows service locations to be hidden and prevents denial-of-service attacks against both the server itself and the services hosting their location information on the EIS.

In some variants, one or more systems above include protocol improvements for communication improve the underlying security, but also integrate the benefits provided by the trust model and EIS server out to every destination. Security improvements include elimination of attacks from anonymous users (zero day or known attacks), protection from denial-of-service attacks, full encryption, and cryptographic identification on every packet. The protocol improvements also support significant performance enhancements, improving the speed and flexibility of connections.

FIG. 31 depicts a high-level flow 3100 (network service security method, e.g.) according to one or more embodiments described herein. Operation 3110 describes configuring one or more servers (having special-purpose circuitry 322) to contain information about one or more authorities and also to contain a first service public key paired with a first service private key (configuring one or more modules 645 so that one or more servers 300B contain information 646 about at least one authority 405A trusted by server 300B and also to so that the one or more servers 300B contain a service public key 631 paired with a corresponding service private key 632, e.g.). This can occur, for example, in a context in which entity 610 implements entity 410 (of FIG. 4) and in which flow 500 (of FIG. 5) has been performed as described above. [Para 162] Operation 3125 describes receiving a first signal from a first entity configured with a first client public key paired with a first client private key and with a first encrypted identity record and with information about the one or more authorities and with a service locator record that includes the first service public key signed by (at least one of) the one or more authorities (configuring one or more modules 645 so that the one or more servers 300 receive a first signal 667 from a first entity 610 configured with a first client public key 611A paired with a first client private key 612 and with a first encrypted identity record 617 and with information 616 about the one or more authorities 405 and with a service locator record 614 that includes the first service public key 631 signed by the one or more authorities 405, e.g.). This can occur, for example, in a context in which the one or more authorities 405 include at least one authority (405A or 405B, e.g.) trusted by the first entity 610 and wherein the first signal 667 includes the first client public key 611A and the first encrypted identity record 617.

Operation 3140 describes decrypting the first encrypted identity record received at the one or more servers with a first session key generated at the one or more servers (configuring one or more modules 645 so that the one or more servers 300 decrypt the first encrypted identity record 617 using an instance of session key 618 generated at the one or more servers 300, e.g.). This can occur, for example, in a context in which the session key 618 would otherwise need to be transmitted from the first entity 610 to the one or more servers 300 in order for both to have the same session key 618 and in which such transmission would put the security of network 602 at risk. In some variants the one or more modules 645 may also configure the first encrypted identity record 617 as a chain of two or more certificates that includes client public key 611 signed by user private key 602 using a first network owner private key 682. Alternatively or additionally, the encrypted identity record 617 and a service locator record 614 that includes service public key 631 signed by the one or more authorities 405 may be configured as identical (by setting one to match a value of the other, e.g.).

Operation 3155 describes communicating something by the one or more servers to the first entity as an automatic and conditional response to a determination that the first encrypted identity record received from the first entity is trustworthy after having generated the first session key partly based on the first client public key and partly based on the first service private key (configuring the one or more modules 645 so that the one or more servers 300 first generate a local instance of session key 618 and later decide to communicate to the first entity 610 as an automatic and conditional response to a determination 644 that the first encrypted identity record 617 received from the first entity is appropriately signed and not garbled, e.g.). This can occur, for example, in a context in which the first entity 610 initiated communication to the one or more servers 300 such that an initial packet of the communication included client public key 611B as described below, in which the automatic and conditional response would otherwise be excessively or insufficiently selective during such an instance of session initiation, in which the determination 644 that the first encrypted identity record 617 received from the first entity 610 is trustworthy includes determining that the first encrypted identity record 617 includes the first client public key 611B properly signed by the one or more authorities 405 (including at least one authority 405A trusted by server 300B, e.g.), and in which authority 405A either consists of a shared password or owns network 602 (as depicted in FIG. 6, with a network owner public key 681 paired with a network owner private key 682).

Operation 3165 describes communicating nothing whatsoever by the one or more servers to a second entity as an automatic and conditional response to a determination that a second session key or second identity record received from the second entity is untrustworthy (configuring the one or more modules 645 so that the one or more servers 300 communicate nothing to “second” entity 620 as an automatic and conditional response to a determination 644 that a second identity record 627 or second session key 628 received from the second entity 620 is untrustworthy, e.g.). This can occur, for example, in a context in which the “second” entity 620 would otherwise use the fact of a non-empty response (an acknowledgment or error message, e.g.) from the one or more servers 300 to confirm a suitable point of entry (into server 300B or network 602, e.g.) toward which to target a denial-of-service or other effective attack.

With respect to the numbered clauses and claims expressed below, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise. Also in the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

### CLAUSES

1. (Independent) A NETWORK SERVICE SECURITY SYSTEM comprising: one or more servers 300 having transistor-based circuitry (a processing module 445, e.g.) configured to contain a first long-term service public key 441A paired with a first long-term service private key 442 and also to contain a first net view publish key 444 and also to contain first connectivity information 449, wherein the one or more servers 300 are configured to interact (via a linkage 461, e.g.) with a first entity 410 (a handheld device, e.g.) having a first net view access key 448 and the long-term service public key 441B (i.e. another instance of long-term service public key 441); and
transistor-based circuitry (another processing module 445, e.g.) configured to transmit a published encrypted service record 443 that includes the first connectivity information 449 encrypted to the first net view access key 448 and signed by the first long-term service private key 442 to the first entity 410, wherein the published encrypted service record 443 is (widely available but) not usable outside the first entity 410 (by virtue of being decryptable only via the net view access key 448, e.g.) and wherein the one or more servers 300 has confirmed a provenance of the encrypted service record 443A by signing the encrypted service record using the first long-term service private key 442.
2. (Independent) A NETWORK SERVICE SECURITY SYSTEM comprising:
transistor-based circuitry configured to contain information 646 about one or more authorities 405 (including at least one authority 405A trusted by server 300B) and also to contain a first service public key 631 paired with a first service private key 632;
transistor-based circuitry configured to receive a first signal 667 from a first entity 610 configured with a first client public key 611A paired with a first client private key 612 and with a first encrypted identity record 617 and with information 616 about the one or more authorities 405 (including at least one authority 405B trusted by the first entity 610) and with a service locator record 614 that includes the first service public key 631 signed by (at least one of) the one or more authorities 405, wherein the first signal 667 includes the first client public key 611A and the first encrypted identity record 617;
transistor-based circuitry configured to decrypt the first encrypted identity record 617 received at the one or more servers with a first session key generated at the one or more servers;
transistor-based circuitry configured automatically to communicate by the one or more servers 300 to the first entity 610 as a conditional response to a determination 644 that the first encrypted identity record 617 received from the first entity is trustworthy, wherein the one or more servers 300 have generated the first session key (an instance of session key 618 in server 300B, e.g.) partly based on the first client public key 611B and partly based on the first service private key and wherein the determination 644 that the first encrypted identity record 617 received from the first entity 610 is trustworthy includes determining that the first encrypted identity record 617 includes the first client public key 611B signed by the one or more authorities 405 (including at least one authority 405A trusted by server 300B); and transistor-based circuitry configured automatically to communicate nothing whatsoever by the one or more servers 300 to a second entity 620 as a conditional response to a determination 644 that a second session key 628 or second identity record 627 received from the second entity 620 is untrustworthy.
3. The system of one or more of the NETWORK SERVICE SECURITY SYSTEM CLAUSES above, wherein some or all of functions recited therein are performed by architectural components depicted in FIG. 7.
4. The system of one or more of the NETWORK SERVICE SECURITY SYSTEM CLAUSES above, wherein some or all of the keying information depicted in FIG. 8 is used in one or more methods described below.
5. The system of one or more of the NETWORK SERVICE SECURITY SYSTEM CLAUSES above, wherein some or all of the key ownership information depicted in FIG. 8 is used in one or more methods described below.
6. The system of one or more of the NETWORK SERVICE SECURITY SYSTEM CLAUSES above, wherein some or all of the user agent keys featuring roles and individual community of interest (COI) membership keys depicted in FIG. 11 is used in one or more methods described below.

FIG. 29 depicts a decision chart showing for a sample key rotation system the critical points that determine the next key tuple used when different actions occur.

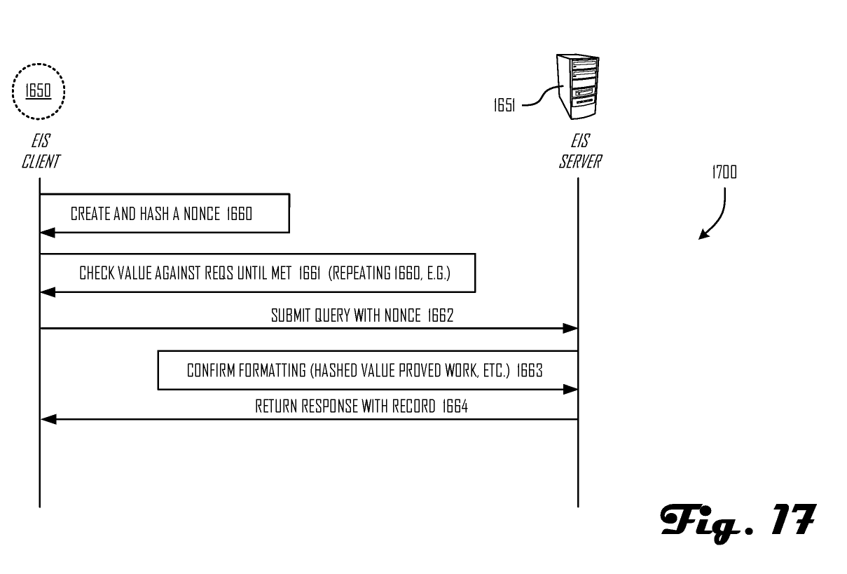

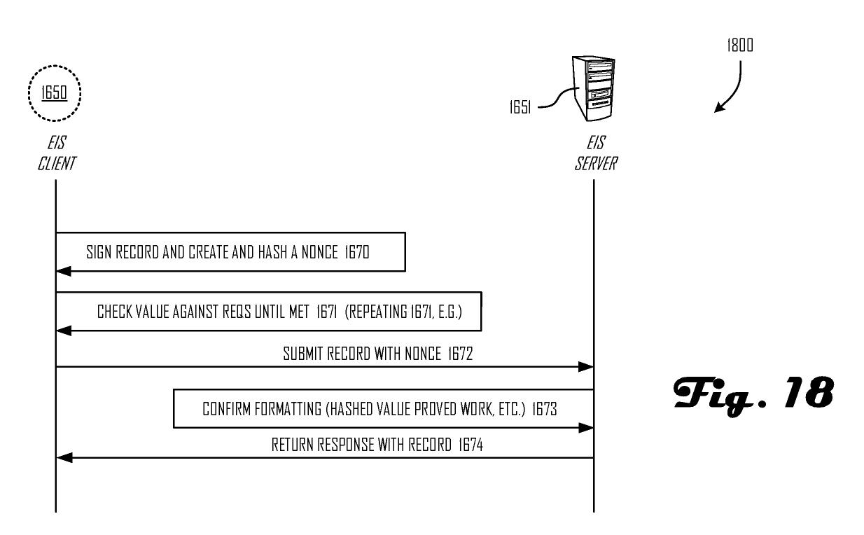

FIG. 30 depicts a communication flow diagram showing an example communication flow in a predictively accepted communication channel.
7. The system of one or more of the NETWORK SERVICE SECURITY SYSTEM CLAUSES above, wherein the system is configured to perform a method of one or more of the NETWORK SERVICE SECURITY METHOD CLAUSES below.
8. (Independent) A NETWORK SERVICE SECURITY METHOD comprising:
configuring one or more servers 300 having transistor-based circuitry to contain a first long-term service public key 441A paired with a first long-term service private key 442 and also to contain a first net view publish key 444 and also to contain first connectivity information 449, wherein the one or more servers 300 are configured to interact (via a linkage 461, e.g.) with a first entity 410 (a handheld device, e.g.) having a first net view access key 448 and the long-term service public key 441B (i.e. another instance of long-term service public key 441); and
invoking (distributed or other) transistor-based circuitry configured to transmit a published encrypted service record 443 that includes the first connectivity information 449 encrypted to the first net view access key 448 and signed by the first long-term service private key 442 to the first entity 410, wherein the published encrypted service record 443 is (widely available but) not usable outside the first entity 410 (by virtue of being decryptable only via the net view access key 448, e.g.) and wherein the one or more servers 300 has confirmed a provenance of the encrypted service record 443A by signing the encrypted service record using the first long-term service private key 442.
9. (Independent) A NETWORK SERVICE SECURITY METHOD comprising: invoking (distributed or other) transistor-based circuitry configured to contain information 646 about one or more authorities 405 (including at least one authority 405A trusted by server 300B) and also to contain a first service public key 631 paired with a first service private key 632;
invoking transistor-based circuitry configured to receive a first signal 667 from a first entity 610 configured with a first client public key 611A paired with a first client private key 612 and with a first encrypted identity record 617 and with information 616 about the one or more authorities 405 (including at least one authority 405B trusted by the first entity 610) and with a service locator record 614 that includes the first service public key 631 signed by (at least one of) the one or more authorities 405, wherein the first signal 667 includes the first client public key 611A and the first encrypted identity record 617;
invoking transistor-based circuitry configured to decrypt the first encrypted identity record 617 received at the one or more servers with a first session key generated at the one or more servers;
invoking transistor-based circuitry configured to communicate automatically by the one or more servers 300 to the first entity 610 as a conditional response to a determination 644 that the first encrypted identity record 617 received from the first entity is trustworthy, wherein the one or more servers 300 have generated the first session key (an instance of session key 618 in server 300B, e.g.) partly based on the first client public key 611B and partly based on the first service private key and wherein the determination 644 that the first encrypted identity record 617 received from the first entity 610 is trustworthy includes determining that the first encrypted identity record 617 includes the first client public key 611B signed by the one or more authorities 405 (including at least one authority 405A trusted by server 300B); and
invoking transistor-based circuitry configured to communicate nothing by the one or more servers 300 to a second entity 620 as an automatic and conditional response to a determination 644 that a second session key 628 or second identity record 627 received from the second entity 620 is untrustworthy.
10. The network service security method of one or more of the NETWORK SERVICE SECURITY METHOD CLAUSES above, further comprising:
configuring a first encrypted identity record 617 as a chain of two or more certificates that includes a first client public key 611 signed by a first user private key 602 using a first network owner private key 682.
11. The network service security method of one or more of the NETWORK SERVICE SECURITY METHOD CLAUSES above, further comprising:
configuring said first encrypted identity record 617 and said service locator record 614 that includes the first service public key 631 signed by the one or more authorities 405 as identical.
12. The network service security method of one or more of the NETWORK SERVICE SECURITY METHOD CLAUSES above, further comprising:
configuring a network owner (authority 405A, e.g.) to generate a first network owner public key 681 paired with a first network owner private key 682, wherein the one or more authorities include the network owner.
13. The network service security method of one or more of the NETWORK SERVICE SECURITY METHOD CLAUSES above, further comprising:
transmitting a first long-term service public key 441 from one or more servers 300 to a network owner, wherein at least a first server of the one or more servers belongs to a network 602 owned by the network owner.
14. The network service security method of one or more of the NETWORK SERVICE SECURITY METHOD CLAUSES above, further comprising:
receiving a first user public key 601 at a network owner; and
configuring the network owner to generate a user certificate (a component of signal 668, e.g.) by signing (an instance of) the first user public key 601 using a first network owner private key 682.
15. The network service security method of one or more of the NETWORK SERVICE SECURITY METHOD CLAUSES above, further comprising:
transmitting the user certificate and a first net view access key 448 and (an instance of) the first long-term service public key 441 (as at least a component of signal 668, e.g.) to the first entity.
16. The network service security method of one or more of the NETWORK SERVICE SECURITY METHOD CLAUSES above, further comprising:
configuring the one or more servers 300 to contain a first net view publish key 444 and also to contain first connectivity information 449.
17. The network service security method of one or more of the NETWORK SERVICE SECURITY METHOD CLAUSES above, further comprising:
transmitting an encrypted service record 443 that includes first connectivity information 449 encrypted to the first net view access key 448 and signed by a first long-term service private key 442 to the first entity.
18. The network service security method of one or more of the NETWORK SERVICE SECURITY METHOD CLAUSES above, further comprising:
updating a private EIS service record like that of FIG. 23 to reflect a new location as an automatic and conditional response to a detection of an attack.
19. The network service security method of one or more of the NETWORK SERVICE SECURITY METHOD CLAUSES above, wherein the first session key is a symmetric key.
20. The network service security method of one or more of the NETWORK SERVICE SECURITY METHOD CLAUSES above, wherein at least one of the one or more authorities 405 is an owner of a network 602 that includes the one or more servers 300.
21. The network service security method of one or more of the NETWORK SERVICE SECURITY METHOD CLAUSES above, wherein at least one of the one or more authorities 405 is a certificate signing authority trusted by the first entity but not by (any of) the one or more servers 300.
22. The network service security method of one or more of the NETWORK SERVICE SECURITY METHOD CLAUSES above, wherein the one or more servers 300 comprise an EIS server 1651 configured to function as depicted in FIG. 17.
23. The network service security method of one or more of the NETWORK SERVICE SECURITY METHOD CLAUSES above, wherein the one or more servers 300 comprise an EIS server 1651 configured to function as depicted in FIG. 18.
24. The network service security method of one or more of the NETWORK SERVICE SECURITY METHOD CLAUSES above, wherein the one or more servers 300 comprise an EIS server 1651 configured to function as depicted in FIG. 19.
25. The network service security method of one or more of the NETWORK SERVICE SECURITY METHOD CLAUSES above, wherein the network is owned by a user agent 1230 configured to function as depicted in FIG. 11.
26. The network service security method of one or more of the NETWORK SERVICE SECURITY METHOD CLAUSES above, wherein the method incorporates the service start process as depicted in FIG. 12.
27. The network service security method of one or more of the NETWORK SERVICE SECURITY METHOD CLAUSES above, wherein the method incorporates the communication flow when a user agent connects to a service as depicted in FIG. 13.
28. The network service security method of one or more of the NETWORK SERVICE SECURITY METHOD CLAUSES above, wherein the one or more servers 300 use the encrypted information server (EIS) data structure as depicted in FIG. 14.
29. The network service security method of one or more of the NETWORK SERVICE SECURITY METHOD CLAUSES above, wherein the one or more servers 300 use the EIS verification steps done when a new record is submitted as depicted in FIG. 15.
30. The network service security method of one or more of the NETWORK SERVICE SECURITY METHOD CLAUSES above, wherein the one or more servers 300 use some or all of the verification steps as depicted in FIG. 16 when a record is retrieved from the EIS by a service, user agent, or other recipient.
31. The network service security method of one or more of the NETWORK SERVICE SECURITY METHOD CLAUSES above, incorporating some or all of the interactions as depicted in FIG. 18 during a communication flow between an EIS client and an EIS server (of the one or more servers 300) during a standard query for a record.
32. The network service security method of one or more of the NETWORK SERVICE SECURITY METHOD CLAUSES above, incorporating some or all of the interactions as depicted in FIG. 19 during a communication flow between an EIS client and an EIS server (of the one or more servers 300) when submitting a record to the EIS server.
33. The network service security method of one or more of the NETWORK SERVICE SECURITY METHOD CLAUSES above, wherein the one or more servers 300 use some or all of the components of the exemplary EIS Information Record of FIG. 20.
34. The network service security method of one or more of the NETWORK SERVICE SECURITY METHOD CLAUSES above, wherein the one or more servers 300 use some or all of the components of the exemplary EIS Approval Record of FIG. 21.
35. The network service security method of one or more of the NETWORK SERVICE SECURITY METHOD CLAUSES above, wherein the one or more servers 300 use some or all of the components of the exemplary Service Ownership Record of FIG. 22.
36. The network service security method of one or more of the NETWORK SERVICE SECURITY METHOD CLAUSES above, wherein the one or more servers 300 use some or all of the components of the exemplary Private Service Record of FIG. 23.
37. The network service security method of one or more of the NETWORK SERVICE SECURITY METHOD CLAUSES above, wherein the one or more servers 300 use some or all of the components of the exemplary User Membership Record of FIG. 24.
38. The network service security method of one or more of the NETWORK SERVICE SECURITY METHOD CLAUSES above, wherein the one or more servers 300 use some or all of the components of the exemplary Public Service Record of FIG. 25.
39. The network service security method of one or more of the NETWORK SERVICE SECURITY METHOD CLAUSES above, wherein the one or more servers 300 use some or all of the components of the exemplary Machine Owner Policy Record of FIG. 26.
40. The network service security method of one or more of the NETWORK SERVICE SECURITY METHOD CLAUSES above, wherein the one or more servers 300 use some or all of the components of the exemplary Public Lookup Record of FIG. 27.
41. The network service security method of one or more of the NETWORK SERVICE SECURITY METHOD CLAUSES above, wherein the one or more servers 300 use some or all of the components of the exemplary Machine Record of FIG. 28.
42. The network service security method of one or more of the NETWORK SERVICE SECURITY METHOD CLAUSES above, wherein certificate 1518 of FIG. 18 is a component of identity record 617 of FIG. 6 and wherein a network owner transmits user membership record 1504 to the first entity.
43. The network service security method of one or more of the NETWORK SERVICE SECURITY METHOD CLAUSES above, wherein encrypted service record 443 comprises some or all of the private service record 1503 as depicted in FIG. 23.
44. The network service security method of one or more of the NETWORK SERVICE SECURITY METHOD CLAUSES above, wherein service locator record 614 comprises some or all of the public service record 1505 as depicted in FIG. 25.

While various system, method, article of manufacture, or other embodiments or aspects have been disclosed above, also, other combinations of embodiments or aspects will be apparent to those skilled in the art in view of the above disclosure. The various embodiments and aspects disclosed above are for purposes of illustration and are not intended to be limiting, with the true scope and spirit being indicated in the final claim set that follows.

What is claimed is:

1. A network service security method comprising:
configuring a network owner to generate a first network owner public key paired with a first network owner private key;
transmitting a first long-term service public key from one or more servers to said network owner, wherein at least a first server of said one or more servers belongs to a network owned by said network owner;
receiving a first user public key at said network owner;
configuring said network owner to generate a user certificate by signing said first user public key using said first network owner private key;
transmitting said user certificate and a first net view access key and said first long-term service public key to a first entity;
configuring said one or more servers to contain a first net view publish key and also to contain first connectivity information;
transmitting an encrypted service record that includes said first connectivity information encrypted to said first net view access key and signed by said first long-term service private key to said first entity, wherein said one or more servers has confirmed a provenance of said encrypted service record by signing said encrypted service record using said first long-term service private key;
invoking transistor-based circuitry configured to contain information about one or more authorities and also to contain a first service public key paired with a first service private key, wherein said one or more authorities comprise said network owner and wherein said first service private key is not said first long-term service private key; invoking transistor-based circuitry configured to receive a first signal from a first entity configured with a first client public key paired with a first client private key and with a first encrypted identity record and with information about said one or more authorities and with a service locator record that includes said first service public key signed by said one or more authorities, wherein said first signal includes said first client public key and said first encrypted identity record;
invoking transistor-based circuitry configured to decrypt said first encrypted identity record received at said one or more servers with a first session key generated at said one or more servers;
automatically communicating by said one or more servers to said first entity as a conditional response to a determination that said first encrypted identity record received from said first entity is trustworthy, wherein said one or more servers have generated said first session key partly based on said first client public key and partly based on said first service private key, wherein said determination that said first encrypted identity record received from said first entity is trustworthy includes determining that said first encrypted identity record includes said first client public key signed by said one or more authorities; and
automatically communicating nothing by said one or more servers to a second entity as a conditional response to a determination that a second session key or second identity record received from said second entity is untrustworthy.

2. The network service security method of claim 1, further comprising:
configuring said first encrypted identity record as a chain of two or more certificates that includes said first client public key signed by said first user private key using said first network owner private key.

3. The network service security method of claim 1, further comprising:
configuring said first encrypted identity record and said service locator record that includes the first service public key signed by the one or more authorities as identical.

4. The network service security method of claim 1, wherein none of said private keys is identical to any of said public keys.

5. The network service security method of claim 1, in which said transmitting said encrypted service record that includes said first connectivity information encrypted to said first net view access key and signed by said first long-term service private key to said first entity comprises:
configuring said first net view publish key as a symmetric key identical to said first net view access key.

6. The network service security method of claim 1, in which said transmitting said encrypted service record that includes said first connectivity information encrypted to said first net view access key and signed by said first long-term service private key to said first entity comprises:
configuring said first net view publish key as a public key paired with a private key that is said first net view access key.

7. The network service security method of claim 1, in which said transmitting said encrypted service record that includes said first connectivity information encrypted to said first net view access key and signed by said first long-term service private key to said first entity comprises:
publishing encrypted service record, wherein encrypted service record is not usable outside said first entity by virtue of being decryptable only via said first net view access key.

8. The network service security method of claim 1, wherein said network owner is said one or more authorities.

9. The network service security method of claim 1, wherein said first user public key signed using said first network owner private key is said user certificate.

10. A network service security method comprising:
invoking transistor-based circuitry configured to contain information about one or more authorities and also to contain a first service public key paired with a first service private key;
invoking transistor-based circuitry configured to receive a first signal from a first entity configured with a first client public key paired with a first client private key and with a first encrypted identity record and with information about said one or more authorities and with a service locator record that includes said first service public key signed by said one or more authorities, wherein said first signal includes said first client public key and said first encrypted identity record;
invoking transistor-based circuitry configured to decrypt said first encrypted identity record received at said one or more servers with a first session key generated at said one or more servers;
automatically communicating by said one or more servers to said first entity as a conditional response to a determination that said first encrypted identity record received from said first entity is trustworthy, wherein said one or more servers have generated said first session key partly based on said first client public key and partly based on said first service private key and wherein said determination that said first encrypted identity record received from said first entity is trustworthy includes determining that said first encrypted identity record includes said first client public key signed by said one or more authorities; and
automatically communicating nothing by said one or more servers to a second entity as a conditional response to a determination that a second session key or second identity record received from said second entity is untrustworthy.

11. The network service security method of claim 10, comprising:
transmitting a user certificate to said first entity, wherein said first entity has a first net view access key and said first long-term service public key; and
transmitting an encrypted service record that includes first connectivity information encrypted to said first net view access key and signed by said first long-term service private key to said first entity, wherein said first service private key is not said first long-term service private key.

12. The network service security method of claim 10, comprising:
configuring a network owner to generate a first network owner public key paired with a first network owner private key, wherein said one or more authorities include said network owner.

13. The network service security method of claim 10, comprising:
configuring a network owner to generate a first network owner public key paired with a first network owner private key, wherein said one or more authorities include said network owner; and
transmitting a first long-term service public key from one or more servers to said network owner, wherein at least a first server of said one or more servers belongs to a network owned by said network owner.

14. The network service security method of claim 10, comprising:
configuring a network owner to generate a first network owner public key paired with a first network owner private key, wherein said one or more authorities include said network owner;
transmitting a first long-term service public key from one or more servers to said network owner, wherein at least a first server of said one or more servers belongs to a network owned by said network owner;
receiving a first user public key at said network owner;
configuring said network owner to generate a user certificate by signing said first user public key using said first network owner private key.

15. The network service security method of claim 10, comprising:
configuring a network owner to generate a first network owner public key paired with a first network owner private key, wherein said one or more authorities include said network owner;
transmitting a first long-term service public key from one or more servers to said network owner, wherein at least a first server of said one or more servers belongs to a network owned by said network owner;
receiving a first user public key at said network owner;
configuring said network owner to generate a user certificate by signing said first user public key using said first network owner private key; and
transmitting said user certificate to said first entity, wherein said first entity has a first net view access key and said first long-term service public key.

16. The network service security method of claim 10, comprising:
configuring a network owner to generate a first network owner public key paired with a first network owner private key, wherein said one or more authorities include said network owner;
transmitting a first long-term service public key from one or more servers to said network owner, wherein at least a first server of said one or more servers belongs to a network owned by said network owner;
receiving a first user public key at said network owner;
configuring said network owner to generate a user certificate by signing said first user public key using said first network owner private key;
transmitting said user certificate to said first entity, wherein said first entity has a first net view access key and said first long-term service public key; and
configuring said one or more servers to contain a first net view publish key and also to contain first connectivity information.

17. The network service security method of claim 10, comprising:
configuring a network owner to generate a first network owner public key paired with a first network owner private key, wherein said one or more authorities include said network owner;
transmitting a first long-term service public key from one or more servers to said network owner, wherein at least a first server of said one or more servers belongs to a network owned by said network owner;
receiving a first user public key at said network owner;
configuring said network owner to generate a user certificate by signing said first user public key using said first network owner private key;
transmitting said user certificate to said first entity, wherein said first entity has a first net view access key and said first long-term service public key;
configuring said one or more servers to contain a first net view publish key and also to contain first connectivity information; and
transmitting an encrypted service record that includes said first connectivity information encrypted to said first net view access key and signed by said first long-term service private key to said first entity, wherein said first service private key is not said first long-term service private key.

18. A network service security system comprising:
transistor-based circuitry configured to contain information about one or more authorities and also to contain a first service public key paired with a first service private key;
transistor-based circuitry configured to receive a first signal from a first entity configured with a first client public key paired with a first client private key and with a first encrypted identity record and with information about said one or more authorities and with a service locator record that includes said first service public key signed by said one or more authorities, wherein said first signal includes said first client public key and said first encrypted identity record;
transistor-based circuitry configured to decrypt said first encrypted identity record received at said one or more servers with a first session key generated at said one or more servers;
transistor-based circuitry configured automatically to communicate by said one or more servers to said first entity as a conditional response to a determination that said first encrypted identity record received from said first entity is trustworthy, wherein said one or more servers have generated said first session key partly based on said first client public key and partly based on said first service private key and wherein said determination that said first encrypted identity record received from said first entity is trustworthy includes determining that said first encrypted identity record includes said first client public key signed by said one or more authorities; and
transistor-based circuitry configured automatically to communicate nothing whatsoever by said one or more servers to a second entity as a conditional response to a determination that a second session key or second identity record received from said second entity is untrustworthy.
